(19) United States
(12) Patent Application Publication
(10) Pub. No.: US 2007/0202481 A1
(43) Pub. Date: Aug. 30, 2007

(54) Method and apparatus for flexibly and adaptively obtaining personalized study content, and study device including the same

(76) Inventors: Andrew Smith Lewis, Tokyo (JP); Brian Tsai, Tokyo (JP); Noriko Nishida, Tokyo (JP)

Correspondence Address: Joseph R. Keating, 2811 Norborne Place, Oakton, VA, 22124, US

(21) Appl. No.: 11/364,437

(22) Filed: Feb. 27, 2006

(51) Int. Cl. G09B 7/00

(52) U.S. Cl. 434/323

(57) ABSTRACT

A method and apparatus to obtain unique study content that is selected based on user's study goals and unique preferences includes having a user input a study goal and study preference. Then a first database of learning content, that may be traditional learning content prepared by an education institution, is queried based on the input study goal and preferences and study items are extracted from the first database. Then, the study items extracted from the first database are stored in a second database, the study items stored in the second database are then used to query a third database of potential learning content, which may include non-traditional learning content, and by matching the study items stored in the second database to content in the third database, study content that has been specifically tailored and personalized based on the user's input study goals and preferences is extracted and presented to the user for study and learning. Since the proven learning content from the first database of learning items is used to match up and extract learning content from a third database of possibly non-traditional learning content, the user is assured to obtain the input study goal using content that is new, flexibly and adaptively obtained and personalized to each user or student, whenever the student wants to obtain fresh, new or different content.

### BACKGROUND OF THE INVENTION

1. Field of Invention

This invention pertains to a method and apparatus for obtaining unique study content that is selected based on a user's study goals and unique preferences, and a study device including the same.

2. Description of the Related Art

Recent years have seen the sale of several types of content matched to study goals, such as, for example, software for learning vocabulary words required for achieving a score of 800 on the TOEIC test and software for mastering intermediate business English. However, the learning content selected based on the prior art methods is typically fixed, inflexible and cannot be personalized or adapted to each user's or learner's preferences and individualized needs, while still ensuring that the user meets the desired study or learning goals. As a result, various learners or users of study devices may be bored and unmotivated by the learning content used by the conventional content obtaining methods and apparatuses, and frustrated that they cannot personalize, individualize or update the learning content while still being assured of obtaining learning goals or preferences.

More specifically, the prior art methods of selecting content for learning involve a simple inquiry based on a learning goal, such as a score of 800 points on the TOEIC test, and then providing a pre-selected, fixed, non-modifiable group of content or list of items to be learned, which will be the learning content or items to be studied and learned by the user. This learning content usually has been pre-selected and fixed many years prior by a professional educational-related company that may have determined that if a user learns certain content, they will achieve a desired learning goal. However, this learning content may be many years old and limited to a certain format such as text or video, that is outdated, boring, and non-changeable, which may lead to boredom and lack of motivation of the user or learner, resulting in them giving up and ultimately failing to achieve their intended goals.

There are content obtaining methods and devices that deliver learning content that is arguably designed for study that is intended not to bore the learner. See, for example, Japanese Unexamined Patent Gazette H1-29889. The language study device described in this Japanese publication extracts the video educational material that the student selects and presents it while also searching the study history recorded for the student for study matter the student can learn at that point and providing instruction to the student. For example, when the video educational material that the student has selected is Japanese culture and the next subjects the student can learn are use of formal language and telephone conversation, the language study device will then check the educational material entitled “Japanese Culture” to see whether these subjects can be studied. If the result of this checking determines that formal language can be learned but telephone conversation cannot, then the segment in the Japanese Culture educational material used for learning formal language is presented for student learning.

Video educational materials may include such topics as drama and news. The study device analyzes in advance the subjects that can be learned in the individual video educational materials, identifies parts that can serve as the subject of learning, and records them in an educational material content information storage unit. The language study device does not determine the order of educational material usage; instead, it provides learning instruction for the fixed, predetermined video educational material that the student has selected. Once the student has selected the video educational material of interest, that video educational material is used to provide study that matches the current learning abilities of the student.

In the study device described above, however, all of the possible learning content that is available for selection and study by the student is fixed and predetermined by someone other than the student. Thus, the student is not able to personalize or continuously choose new, interesting and unique content that the student particularly wants to study, while still being able to achieve the student's learning goal. For example, TOEIC preparation software targeting a score of 800 points, only content which has been prepared in advance (and is likely to be quite outdated) for achieving a TOEIC score of 800 points, is available. The problem is that the user cannot flexibly select the content he likes and the user can choose only the content that is fixed and prepared in advance usually by an educational instructor for a certain specific study purpose, though the user would be more motivated to study the content the user likes or is interested in, or in a particular format or from a particular source that the user is most interested in and most likely to be motivated to study. Whenever the same fixed, predetermined, outdated and non-varying format study matter is studied, the same questions and examples appear and the video that is replayed is the same. This leads to significant boredom, lack of motivation and disinterest of the student, making it less likely that the student will use the learning device or system as frequently as expected. This will result in the student not learning as he should and not being able to achieve the desired learning goal.

When the same fixed, predetermined, unchangeable content is used each time a particular subject is studied, interest is lessened and the learner's motivation declines. Since the content is unchanging and cannot be personalized for each student, the student is also unable to study content from real-time or up-to-date current content available from a variety of sources such as the internet and television. For example, even if a student could use an American news television program for TOEIC study, a learner would have to always study an old news program or specially created content to study the same vocabulary words. Since the same study matter is always studied using the same content, the student can memorize the answers without mastering the subject matter, thereby diminishing the learning effect. Since the same fixed, predetermined and unpersonalized content is used for study each time, its practical usefulness in the real world is significantly decreased. Also, for example, when there is study matter that is duplicative but which is used for different purposes, such as for achieving a TOEIC score of 800 or STEP Level 1, the user needs to purchase both conventional sets of study matter, and the user has to study the same items which the user mastered in TOEIC when the user studies STEP Level 1.

The limitations of the background art as described above, including but not limited to inflexible study content, lack of personalization or user selection, and outdated materials, lead to a significant potential for decreasing motivation of the user or student, increasing the burden of self-management and wasted time for the user or student, ultimately having a negative effect on the likelihood that the user or student will achieve their learning goals.

### SUMMARY OF THE INVENTION

In order to overcome the problems described above, preferred embodiments of the present invention provide a method and apparatus for obtaining unique study content that is selected based on user's study goals and unique preferences, and a study device which includes the same, that enables study content to be matched to individual and changing preferences, formats, sources of content, etc. while still ensuring that the user's study goals are achieved by using content that is of greatest interest to each learner that is selected at any time by the user from among a wide range of content.

In addition, according to various preferred embodiments of the present invention, a method and apparatus obtain unique study content that is selected based on user's study goals and unique preferences and involves having a user input a study goal and study preference, then a first database of learning content, that may be traditional learning content prepared by an education institution, is queried based on the input study goal and preferences and study items are extracted from the first database, the study items extracted from the first database are stored in a second database, the study items stored in the second database are then used to query a third database of potential learning content, which may include non-traditional learning content, and by matching the study items stored in the second database to content in the third database, study content that has been specifically tailored and personalized based on the user's input study goals and preferences is extracted and presented to the user for study and learning. Since the proven learning content from the first database of learning items is used to match up and extract learning content from a third database of possibly non-traditional learning content, the user is assured to obtain the input study goal using content that is new, flexibly and adaptively obtained and personalized to each user or student, whenever the student wants to obtain fresh, new or different content.

Since the method and apparatus of various preferred embodiments of the present invention extracts items necessary to achieve the study goal, it enables efficient learning of items that match the individual's study goal and unique study preferences such as a particular format, source of content, modality of presentation of learning content, etc. This maximizes each unique individual's interest, motivation and usage of the learning apparatus and avoids problems with boredom, frustration with fixed and outdated content, while ensuring the user can obtain new and more interesting content continuously at any time. As such, the method and apparatus of the present invention presents a more efficient, and motivating meaning of achieving the user's or student's ultimate goal, providing a much higher likelihood of continued use and greatly enhancing the value and benefits of the learning process, ultimately increasing the user's ability to reach their personalized goals.

Also, since the items and content are stored independently in the first, second and third databases, there is a great degree of freedom in being able to select new, personalized content from various sources and in various formats that can be used toward achievement of the study goal. The user is able to study appropriately for achievement of the goal using the learning content that is of greatest interest to the user. Since interest is increased by being able to study items from different and perhaps non-traditional up-to-date learning content, and in various formats, modalities, and other characteristics, user motivation is maximized. For example, when the user reviews an item, content different from the original content obtained from the traditional learning database (first database) can be used. Further, the problem of memorizing responses of the same fixed, unchanging and outdated content without learning the topic is eliminated. The ability to apply learning to different situations can also be cultivated by use of study items using different content. Materials that are actually used or offered on a continuously refreshed or renewable basis in the real world (e.g., video, audio, images, text, etc. from various television, internet, DVD, CD, and other media) can also be used as study content.

Since the method, apparatus and system for obtaining unique study content that is selected based on the user's study goals and unique preferences obtains new, highly personalized and continuously renewable content that is most interesting to each user, the user's interest level, motivation, frequency of study and effectiveness of the study method or device is maximized, while also ensuring that the user's input study goal is achieved. Since items from a proven learning content database are used to match-up and extract learning content from a user-selected database of possibly non-traditional learning content, the user is assured to obtain the input study goal using content that is new, flexibly and adaptively obtained and personalized to each user or student, whenever the student wants to obtain fresh, new or different content.

Also, since the items used to extract content from the user-selected database and the content extracted from the user-selected database are stored independently, there is a high degree of freedom in being able to select new, personalized and possibly non-traditional learning content that can be used toward enabling the user to achieve the input study goal. Because the user is able to study appropriately for achievement of the goal using the most interesting and personalized content and user attention, motivation and learning is maximized. For example, when the user reviews an item, content different from the original content can be used. Further, the problem of memorizing responses to predetermined fixed questions without learning the topic is eliminated. The ability to apply learning to different situations can also be cultivated by the use of study items using different content. Materials that are actually used in the real world can also be used as content.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a flowchart illustrating a method of obtaining learning content according to various preferred embodiments of the present invention.

FIGS. 2a and 2b are schematic drawings of learning content obtaining systems according to various preferred embodiments of the present invention.

FIG. 3 is a schematic drawing of a study system according to a preferred embodiment of the present invention.

FIG. 4 is a function block diagram of a study system according to a preferred embodiment of the present invention.

FIG. 5 is a table that shows an example of data stored in a first database, which is also referred to as an item database.

FIG. 6 is a table that shows an example of data stored in a second database, which is also referred to as a My List database.

FIG. 7 is a graph that illustrates the Expanded Rehearsal Series.

FIG. 8 is a table that shows the review curve.

FIG. 9 is a function block diagram of a study terminal according to a preferred embodiment of the present invention.

FIG. 10 is a flowchart that shows the operation of a study system according to a preferred embodiment of the present invention.

FIG. 11 is a flowchart that shows the operation of a study system according to a preferred embodiment of the present invention.

FIG. 12 shows a sample display of the study goal setup screen.

FIG. 13 shows a content selection screen.

FIG. 14 shows a content replay screen.

FIG. 15 shows a content replay screen.

FIG. 16 shows a content replay screen.

FIG. 17 shows an example of a screen that displays a description of an item.

FIG. 18 shows a screen that displays study results and progress.

FIG. 19 shows a My List editing screen.

FIG. 20 is a flowchart that shows the operation of a study system according to a preferred embodiment of the present invention.

FIG. 21 is a flowchart that shows the operation of a study system according to a preferred embodiment of the present invention.

FIG. 22 shows an example of display of a content selection screen.

FIG. 23 is a flowchart that shows the operation of a study system according to a preferred embodiment of the present invention.

FIG. 24 is a flowchart that shows the operation of a study system according to a preferred embodiment of the present invention.

### DETAILED DESCRIPTION OF PREFERRED EMBODIMENTS

Preferred embodiments of the present invention will be described below with reference to the figures. To facilitate understanding of the explanation, identical constituent elements are given the same reference numbers in all drawings and redundant explanations are omitted.

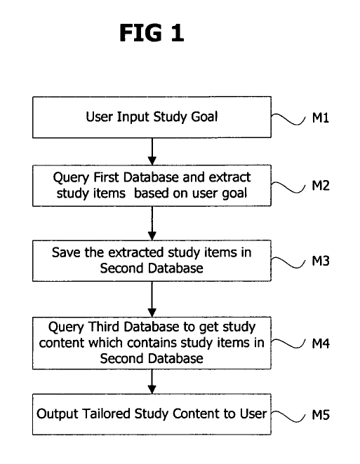

FIG. 1 is a flowchart illustrating the steps of a method for obtaining learning content according to a preferred embodiment of the present invention. In the first step, M1, the user is asked to input a study goal through an input of the study device 100. As noted above, the study goal could be a certain desired performance level on a standardized test, such as a score of 800 on the TOEIC exam. The type of study goal is not limited in the present invention and can be any quantitative or qualitative goal that can be input numerically, textually, pictorially, etc. Once the user has input the study goal at step M1, the apparatus and method query a first database 101 to extract items or learning content based on the input study goal. The first database 101 is typically and preferably a database of items stored on any recording medium (e.g., the memory of a microprocessor based system, DVD, CD Rom, etc.), which items have been determined by an educational institution or a company to be most likely or proven to enable a student to achieve the input learning or study goal. For example, for the input study goal of a score of 800 on the TOEIC exam, a database of learning content prepared by an educational company might serve as the first database 101. The output of step M2 might be a group of 1,000 items or words to be learned to achieve the TOEIC 800 score.

Next, in the step M3, the extracted items from step M2 are stored in a second database 102 which is preferably part of the apparatus. By storing the extracted items in the second database 102 in step M3, these items can be used independently and repeatedly in a manner described below to obtain additional learning content that is new, personalized and uniquely selected based on the user's personal preferences while still ensuring achievement of the input study goal.

In step M4, the extracted items from the second database 102 are used to query a third database 103 by matching one or more of the extracted items from second database 102 to items or content contained in the third database 103. Note that the particular database that forms the third database 103 is not limited in the present invention and may preferably include a non-traditional learning content database and may be from a variety of content sources such as television, radio, DVD, CD, internet, etc. The variety of content sources may include a “closed” content source such as content recorded on a DVD or CD, and can include an “open” content source such as a database that can be accessed and queried via the internet.

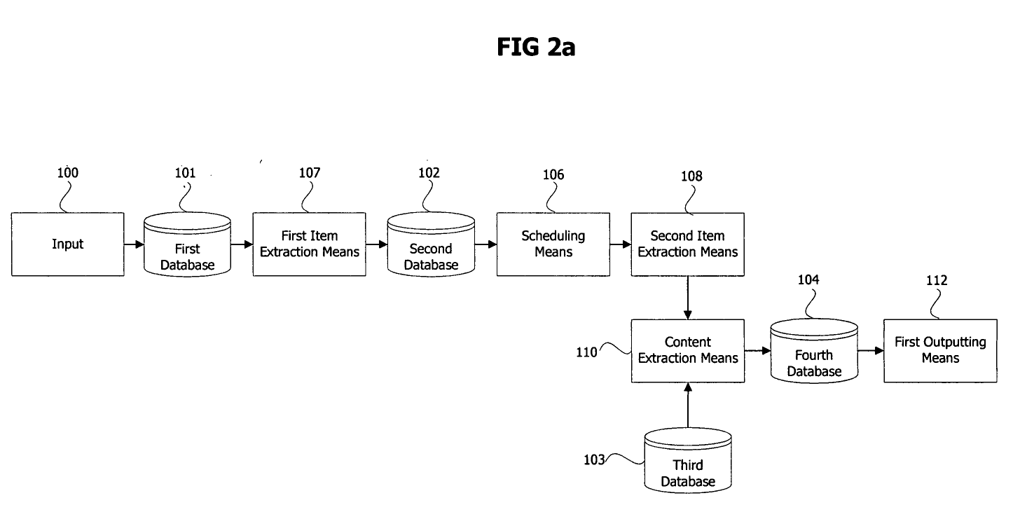

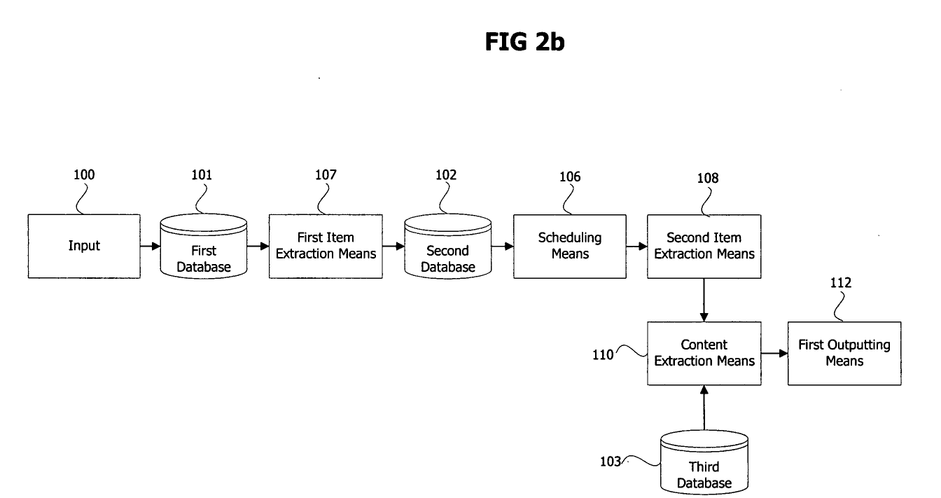

In a specific example of step M4, at least one item from the second database 102 is used as a matching element to match to the same element in the third database 103. It should be noted here that the particular third database 103 can be determined by the system, by the user or by an administrator or teacher or other individual. For example, assume the at least one item from second database 102 is a word in text format that must be learned to achieve the TOEIC 800 score. In the traditional learning process using first database 101, that word is perhaps presented in textual form in a story or flashcard type application. However, now the word from the second database 102 is used to find new, possibly non-traditional learning content from another database 103, which may be in the form of a news story in a desired format (video, text, audio, etc.) that uses the selected word. If there is such a match, that news story from the third database 103 is extracted and may be stored in a fourth database 104 (see FIG. 2a) for presentation to the user, or may be presented to the user without being stored in a database such as the fourth database 104, as will be described with respect to FIG. 2b.

It should be noted that the particular process of searching for and obtaining new content from the third database 103 using items from the second database 102 is not limited and may be done in many ways. For example, this process can utilize a web crawler and related process as described in U.S. Pat. No. 6,965,900; a search engine and related process as described in U.S. Pat. No. 6,895,405; one or more search robots and related processes as described in U.S. Pat. No. 6,804,675; or any other suitable content search and retrieval tool or process.

In step M5, the new learning content stored in fourth database 104 is presented to the user preferably using an appropriate learning device or engine, such as that described in U.S. Pat. No. 6,652,283, the disclosure of which is hereby incorporated by reference.

The above-described process shown in FIG. 1 can be repeated for each of the other items in second database 102 that have been extracted from the first database 101 based on the user's input study goal. This process can be carried out on an item-by-item basis using each item stored in the second database 102, or can be carried out all at once using a group or all of the items stored in the second database 102.

FIGS. 2a and 2b are schematic diagrams of an apparatus for flexibly and adaptively obtaining new learning content based on user input learning goals and preferences using the process described with respect to FIG. 1. The apparatus shown in each of FIGS. 2a and 2b preferably includes an input of the study device 100 where a user can input information, and a first database 101 that receives the input user's goal that is input at step M1 of FIG. 1. As noted above, the first database 101 preferably includes standardized learning content that is fixed and has been proven to achieve various learning goals that might be input by a user. The first database 101 is operatively linked to the second database 102 by an item extraction means 107 described in more detail later. The item extraction means 107 takes one or more items from the first database 101 based on the user input learning goal and/or learning preferences and transmits these extracted learning items to be stored in the second database 102. A scheduling means 106 determines which items are most in need of presenting to the user or learner and provides identification data to a second item extraction means 108 to enable the second item extraction means 108 to extract the items most in need of presenting to the user from the second database 102.

It should be noted that although not specifically shown in FIG. 2a, the items extracted from the second database 102 by the second item extraction means 108 could be presented directly to the user, as is done with the process described in U.S. Pat. No. 6,652,283. However, in preferred embodiments of the present invention described below, the items extracted from the second database 102 by the second item extraction means 108 are preferably used to obtain new, interesting, and motivating content from a third database 103.

More specifically, the items extracted from the second database 102 by the second item extraction means 108 are preferably used by a content extraction means 110 via a matching process (described above) to extract items from a third database 103. As described above, the second item extraction means 108 uses one or more items from the second database 102 to match up with items from a third database 103, which can be any variety of databases of content that could be used for learning, but that is preferably non-traditional learning content.

As seen in FIG. 2a, the content from the third database 103 extracted by the content extraction means may be stored in a fourth database 104 and presented to the user via a suitable learning device or system such as the learning engine described in U.S. Pat. No. 6,652,283.

Alternatively, as seen in FIG. 2b, the fourth database 104 can be omitted, and the items from the third database 103 extracted by the content extraction means 110 may be presented directly to the user, preferably by a suitable learning device or system such as the learning engine described in U.S. Pat. No. 6,652,283, without first being stored in a database, such as the fourth database 104.

It should also be noted that in the preferred embodiments of the present invention shown in FIGS. 2a and 2b, there are several options for which items or content can be presented to the user. More specifically, only the items from the second database 102 can be presented to the user, only the content or items extracted from the third database 103 (and optionally stored in the fourth database 104) can be presented to the user, or a combination of items from the second database 102 and the items or content from the third database (which may be optionally stored in the fourth database 104) can be presented to the user.

With the method of FIG. 1 and the apparatuses of FIGS. 2a and 2b, a student or user is able to easily and quickly obtain new learning content that will ensure achievement of the learning goal, but is highly personalized and adapted to the user's preferences, and can be updated and renewed as often as the user likes. As a result, learning content that will enable achievement of learning goals and maximize the user's interest, attention, motivation and use of the learning system or device so as to optimize the learning process, can be easily and repeatedly selected by the user based on each individual user's personal preferences, even if such preferences change over time.

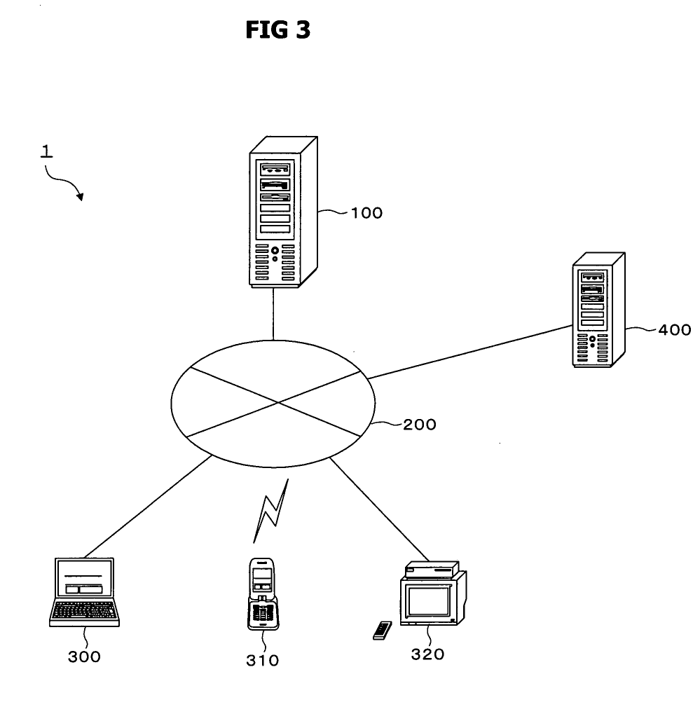

In the following paragraphs, specific examples of various preferred embodiments of the present invention will be described. FIG. 3 is a schematic diagram showing the arrangement of study system 1. Study system 1 preferably includes, for example, a study device 100 and PC 300 (a study terminal). Study device 100 and PC 300 are connected by and can communicate through network 200. Study device 100 provides scheduling and educational materials appropriate for study goals based on information received from PC 300. The study goal is information that may include a field of study, such as everyday conversation in a certain language, finance, or natural sciences, and achievement goals, such as beginner level, intermediate level, advanced level, TOEIC 600 points, and the like. The user can set the field of study and the study goal, such as the type and level of test, and the items are extracted to match the study goal, eliminating the trouble of finding the educational material.

PC 300 accepts user input and sends user instruction information to study device 100, while also receiving item and content information from study device 100 and providing study services to the user. The functions of PC 300 are executed by dedicated applications (study applications).

The study terminal may be, in addition to PC 300, something like mobile phone 310 or STB 320, or other suitable processor or microprocessor based system. The study terminal may also be a mobile terminal such as a PDA. External server 400 is conceptually an ordinary external server that provides Web pages and other content and refers to a nonspecific server.

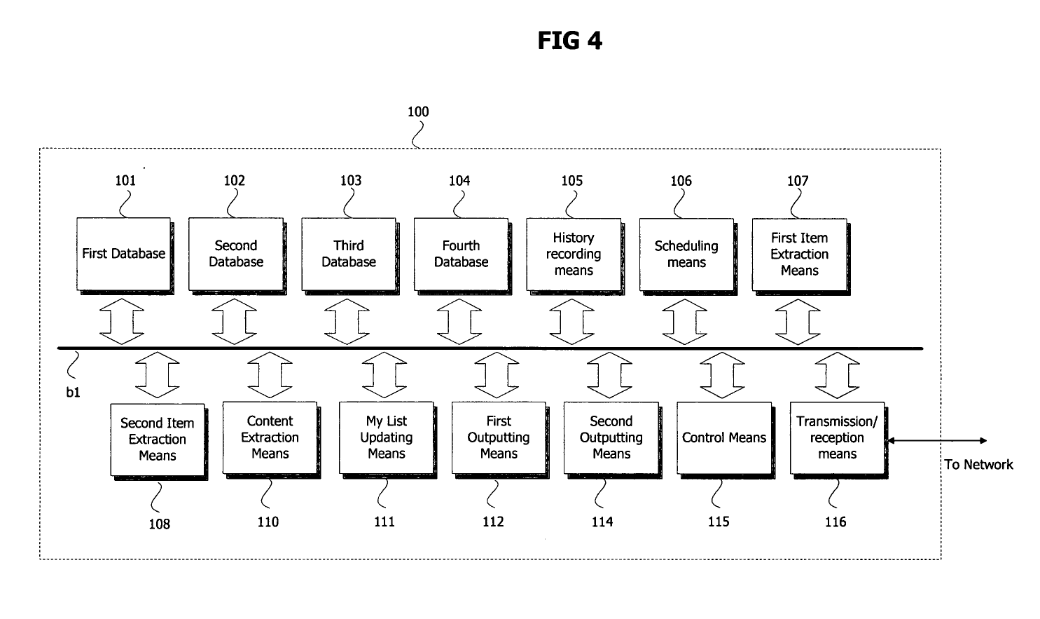

FIG. 4 is a block diagram that illustrates the electrical arrangement of study device 100. As FIG. 4 shows, study device 100 has a first database 101 that is an item database, a second database 102 that is a My List database, a third database 103 that is a content database, a fourth database 104 that is a personalized study content database, a history recording means 105, a scheduling means 106, a first item extraction means 107, a second item extraction means 108, a content extraction means 110, a second database updating means 111 that is a My List updating means, a first outputting means 112, a second outputting means 114, a control means 115, and a transmission/reception means 116, all of which are connected by control bus b1.

The first database 101 is an item database that stores the content or items that are the subject of study. The term “item” refers to the smallest structural unit that the user studies, and may be a vocabulary word, a phrase, a sentence, an image, a sound, etc. The items stored in the first database 101 preferably include items from various fields of study and are each stored with associated information such as level, anticipated learning time, and other related information (such as usage examples or sound files). The first database 101 is preferably stored in memory such as RAM or ROM or external memory devices such as hard disks.

The second database 102, also referred to as the My List database, records items required to achieve goals for individual users. Study device 100 manages items for each user and is thereby able to provide study items tailored to each individual user's needs. “My List” of the second database 102 refers to a unique list of items created for each individual user. The items recorded in the second database 102 can be corrected, added to or deleted by user operations, administrator operations or by the system, after studying begins. When the user finds a study item he or she wishes to learn, the device 100 can add that item to the list in the second database 102 and include it thereafter in the schedule of items to be presented to the user. Learning efficiency is increased because, when the user wishes to delete an item after adding it, the user can remove the item from the list, and the user can also return a deleted item to the list, so study can be restricted to only items necessary for study, so user's needs are met. Items can be updated by adding or deleting items. Along with the update, scheduling means 106 decides the compatibility with study goals again, and when it decides the study goal is not appropriate, that information is sent to user. On the second database (My List database) 102, the item status—Not Mastered, Being Mastered, Mastered, or Deleted—is also recorded with the item. The second database 102 is preferably stored in memory such as RAM or ROM or external memory devices such as hard disks.

The third database 103, which is also a non-traditional learning content database, stores content that may not be intended to but can serve as the subject matter of study, and may be in any type of format such as text data, images, whether still or moving, and sound data, or any other content that might be used for learning. The third database 103 preferably contains content that is not specifically prepared for learning but can be used to study and achieve learning goals. Also, the third database 103 preferably includes current, up-to-date information or content from a variety of sources. Various content from the third database 103 can be imported for use by the device 100 through the use of content extraction means 110 as described in more detail later. The third database 103 is preferably stored in memory such as RAM or ROM or external memory devices such as hard disks.

Since the items from the traditional learning database, first database 101, the selected personal items in the second database 102, and the potentially new learning content in the third database 103 are stored independently in this manner, there is a high degree of freedom in being able to select personalized, current and unique content that can be used to achieve the study goal. The user is able to study appropriately for achievement of the study goal using content that is of greatest interest to that particular user. Since user interest is maximized by being able to study items from different content sources in different formats as selected by each individual user, user motivation is increased. For example, when the user reviews an item, content different from the original content from the fixed, outdated learning content from first database 101 can be used. Further, the problem of memorizing responses without learning the topic is eliminated. The ability to learn and study using personally and flexibly select content from any number of real world, up-to-date content sources that can be used for learning provides unique advantages of high interest, attention, motivation to most efficiently achieve the user's study goals.

The fourth database 104, or personalized study content database, includes content that has been extracted from the third database 103 by the content extraction means 110. Thus, the fourth database 104 includes content from the third database 103 that has been selected on the basis of the items from the second database 102. The fourth database 104 is preferably stored in memory such as RAM or ROM or external memory devices such as hard disks.

History recording means 105 records information about the history of the user's learning. As described in U.S. Pat. No. 6,652,283, the history information may include information indicating the degree of completion for study of each item and all other actions taken when the user was studying. For example, the history information may include study start time, content information, study time for each single item, answering time, correct/incorrect, mistaken items selected as answers when a multiple choice test was answered incorrectly, time to read stories, listening speed, etc. The history information can also be divided into study history seen from a macro perspective and study history seen from a micro perspective. For example, study history information seen from a macro perspective includes the studying frequency of a given user, while study history information seen from a micro perspective includes time required to answer when a given item appears on a quiz. History recording means 105 is preferably stored in memory such as RAM or ROM or external memory devices such as hard disks.

The first database 101, the second database 102, the third database 103, the fourth database 104, and history recording means 105 are each explained as conceptually independent databases, but the first database 101 and the second database 102 can be physically part of the same database or all of these databases can be combined into one integrated database.

As described with respect to the “Schedule” module in U.S. Pat. No. 6,652,283, scheduling means 106 (study management system) manages the user's study schedule. Scheduling means 106 accesses history recording means 105 and the second database (My List database) 102 and identifies items that must be studied or tested in the current learning session. In other words, scheduling means 106 analyzes history information and item information recorded in the second database (My List database) 102 and determines which items that must be studied and/or tested in the current session. The items selected by the scheduling means 106 are extracted by second item extraction means 108 and presented to the user, preferably using the learning engine described in U.S. Pat. No. 6,652,283. When it identifies items that must be studied and/or tested in the current session, scheduling means 106 preferably identifies items to be presented to the user based on the theories of Expanded Rehearsal Series or other suitable algorithm. Also, scheduling means 106 instructs content extraction means 110 to extract content that includes the items that must be studied and/or tested in the current session from the third or content database 103. Scheduling means 106 preferably includes a CPU and a computer program executed by the CPU.

First item extraction means 107 searches for and extracts items from the first database 101 that must be studied and/or tested to achieve the study goal. Since it extracts items necessary to achieve the study goal, first item extraction means 107 enables efficient learning of items that match the individual's study goal. First item extraction means 107 extracts items from the first database 101 based on the input learning or study goal, the user history and/or the input current status. The input current status may include the user's knowledge or language ability level, the field to be studied, and the like. For example, if the goal is 700 points on the TOEIC and the user's current level is 500 points, the user must gain 200 points to achieve the goal. Also, for a user who has finished studying finance and wishes to study accounting, the items that must be studied are those from the accounting field minus those from the finance field. First item extraction means 107 preferably includes a CPU and a computer program executed by the CPU.

Also, the second item extraction means 108, also referred to as the learning engine item extraction means, receives the scheduling result from scheduling means 106 and extracts items from the second database 102 in order to populate the learning engine with items to be studied, reviewed or tested. The second item extraction means 108 extracts items from the second database 102 which are identified to study by scheduling means 106 preferably based on the history or the input current status. An item whose status has become Mastered or Deleted is not extracted by the second item extraction means 108. This means that the user does not on his or her own have to keep track of the parts to be studied and the parts that have already been studied, enabling learning that avoids duplicating such parts. For example, when there is study matter that is duplicated but which is used for different purposes, such as for TOEIC 800 Points or STEP Level 1, there is no longer any need to study both study contents of TOEIC 800 Points and STEP Level 1. The user automatically only studies items required to fill in missing knowledge, avoiding wasted effort and improving learning efficiency. The second item extraction means 108 preferably includes a CPU and a computer program executed by the CPU.

Content extraction means 110 may include an open content processor, which accesses external server 400 and matches content data contained in external server 400 to items contained in the second database 102 using any of the processes described above, and can either import and store the extracted content data into the fourth database 104, or can transmit the extracted content for presenting directly to the learner or user, preferably via the learning engine, without being stored beforehand.

For the matching described above to populate third database 103, the items contained in the second database (My List database) 102 and outside server 400 can be matched, using any existing search engine available through the internet or other source, or any other known software data matching and extraction program such as those described above. For example, when an item to be study or learned, e.g. “neuroscience” is contained in the second database 102 and has been identified by the scheduling means 106 to be presented to the user, the content extraction means 110 uses that item “neuroscience” as a search query to search the outside server 400 or third database 103, which may be a predetermined news web page (e.g., a website for XYZ news selected by the user, administrator or the system). More specifically, content extraction means 110 inputs the query “neuroscience” to the predetermined website, and obtains or extracts appropriate news information and content, which includes the keyword “neuroscience,” from the website by using a known search engine or any of the search and retrieval tools and processes described above. As a result, content which is not usually available or used for study and learning can be stored in the fourth database or presented directly to the user, so as to be used for study and learning so that the user can obtain the input study goal.

The user can input the search conditions from PC 300. To allow the user to set search information such as desired categories, formats and sources of new content, a search screen displayed on PC 300 displays check boxes, command buttons, text boxes and the like. Content extraction means 110 may automatically match the user-input search conditions to the items and content data recorded in the second database 102 as needed.

Also, content extraction means 110 can match web page data to items on My List and displays processed web pages. When this happens, the user simply browses the Web and items to be studied on the displayed web pages are displayed with emphasis, i.e., the items to be studied are preferably highlighted in color, bold text, larger text, blinking text, audio signals, etc. Content extraction means 110 preferably includes a CPU and a computer program executed by the CPU.

Also, the content extraction means 110 may include a closed content processor, which also matches items and content. In other words, content extraction means 110 searches the third database 103 for content that matches the items to be studied. In its matching, it checks which items in the second database (My List database) 102 are included in the content. Content extraction means 110 also extracts content that contains the items as potential content for a particular study lesson.

Doing this sort of matching enables, for example, learning using content that is completely personalized and selected by each individual user so as to maximum user interest and motivation, which thereby ensures that the user's learning goal is achieved in the most efficient manner possible. The items to be studied are determined in advance for each level and the user's study goal is set. Study content is then displayed emphasizing only the items that correspond to the study goal.

When extracting potential content, specific criteria can be set up to narrow the range of content considered and selected. The criteria should preferably assign a higher rank to content that is more effective for study. For example, the more items it includes, the higher the study effect of the content. Also, the greater the study urgency of the items it includes, the higher the study effect of the content. “Study urgency,” which is described in Applicants' U.S. patent application Ser. No. 10/012,521, refers to the need to study at that point in time, which is determined by the study histories for the individual items. The study urgency for a given item is determined by factors such as the period when the item was studied previously, the number of times the item was studied, the correct answer ratio on tests, the speed of response, the difficulty of tests which elicited wrong answers, and the total study time. For example, an item studied 30 days previously has a higher urgency than an item studied 10 days previously. Content extraction means 110 does not function when the user specifies the content to be studied directly. Also, an index that totals the product of the number of items included and their urgency is good as a specific criterion to narrow the range of potential content. For example, if there are four items with urgency 0.1 and three with urgency 0.2, the content index is (0.1×4)+(0.2×3)=1. This kind of weighting can be used to calculate indexes for each piece of content, compare indexes, and select the higher scoring content as the potential content.

Also, content extraction means 110 extracts content in a format that matches the study terminal and the user's input desired format. For example, if the study terminal is mobile telephone 310, it extracts content for mobile telephones and in a format chosen by the user (e.g., text, video, audio). When the third database 103 does not have any content prepared for mobile telephones, original content is converted to a file format and size for mobile telephones.

Second database updating means (My List updating means) 111 receives information input by the user from PC 300 (study terminal) and adds items to or deletes items from My List. The second database updating means 111 also accepts input information from the user and changes item status. There are three item statuses: Not Mastered, Mastered, and Deleted. For example, if the user has mastered the term “beneficial,” second database updating means 111 will change the status of “beneficial” from Not Mastered to Mastered. An item whose status has become Mastered or Deleted is not extracted by second item extraction means 108. Second database updating means 111 preferably includes a CPU and a computer program executed by the CPU.

First outputting means 112 (learning content outputting means) creates study content data and sends it to PC 300. “Study content” may refer to, for example, content in which items to be studied included in selected content is displayed with emphasis. Displaying with emphasis may consist of displaying the subject item enlarged, in boldface type, underlined, blinking, different colors, or displaying the subject item only. First outputting means 112 preferably includes a CPU and a computer program executed by the CPU.

Because the extracted items are emphasized in the display in the study content, the way in which the item is used is readily understood and the user's learning is facilitated. It is also easy to provide functions such as display of an item's meaning and pronunciation when the user clicks on the item.

Because first outputting means 112 processes content selected by the user to display it with emphasis in this way, it may enable, for example, learning to be done using a variety of programming for learners of varying abilities. The study items are determined in advance for each level and only the items that correspond to the preset study goal are displayed with emphasis when the study content is displayed again.

During review, second outputting means 114 (content history archive data outputting means) reads history information related to the item the user specified from history recording means 105 and outputs study content that was used for learning the item from the history information. For example, when the user specifies a particular item, a clip button is displayed to indicate the content field. The fields displayed include the study content that was used to study that item. When the clip button is clicked, the titles of the pieces of content are displayed in a list; when a particular title is then clicked, that content is replayed. Content replay preferably includes image and sound output. It should ideally display only the sentence from the study content that used the item that was studied or that sentence plus the sentences around it. Display of the part that used the item that was studied makes checking easy and increases the effectiveness of review. This allows easy confirmation of examples of use of the studied item and can deepen understanding.

Control means 115 preferably includes a CPU and a computer program executed by the CPU and controls all the individual components 100-114 which were described previously. Also, transmission/reception means 116 is an interface from study device 100 to network 200 that receives content data, sends study content data, receives selection information, and so on. Also, control bus b1 is conceptually shown as a trunk line that is used to send and receive signals and data between the individual components.

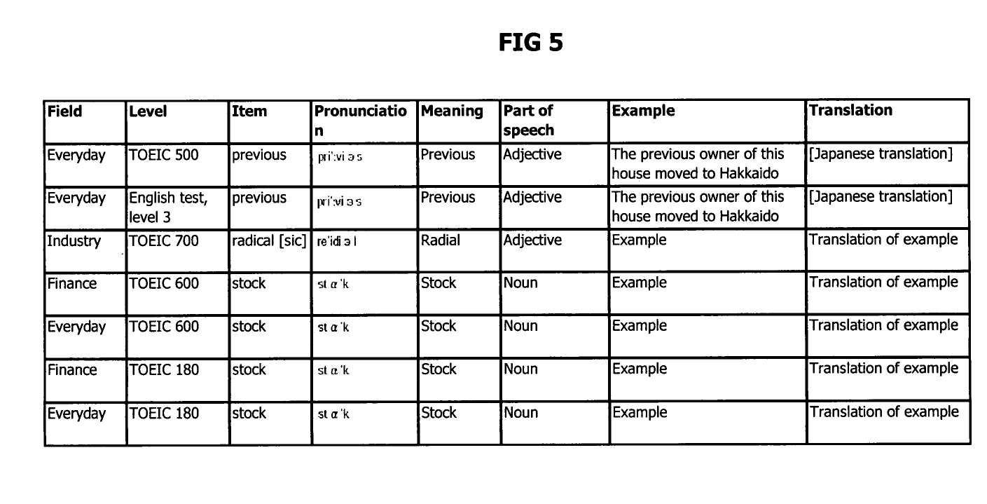

Next, the items and item attributes that are stored in the databases will be explained. FIG. 5 is a table that lists the items and item attributes that are stored in the first database 101. As FIG. 5 shows, the items are recorded with associated study goals. Study goals are categorized by fields and levels. For example, the word “previous” is extracted by first item extraction means 107 when the user selects the field “everyday.” When the user selects the field TOEIC500, “previous” is also extracted.

Other information associated with the item “previous” that is recorded is the pronunciation “pri':vi [symbol] s,” the meaning “prior,” the part of speech “adjective,” the sample sentence “The previous owners of this house moved to Hokkaido,” and the sample sentence translation “kono ie no izen no mochinushi wa hokkaidou ni hikkoshimashita.” When “previous” is extracted, these attributes, including the study goal, are also extracted. The table shown in FIG. 5 is only one example; more or fewer types of attributes may also be recorded.

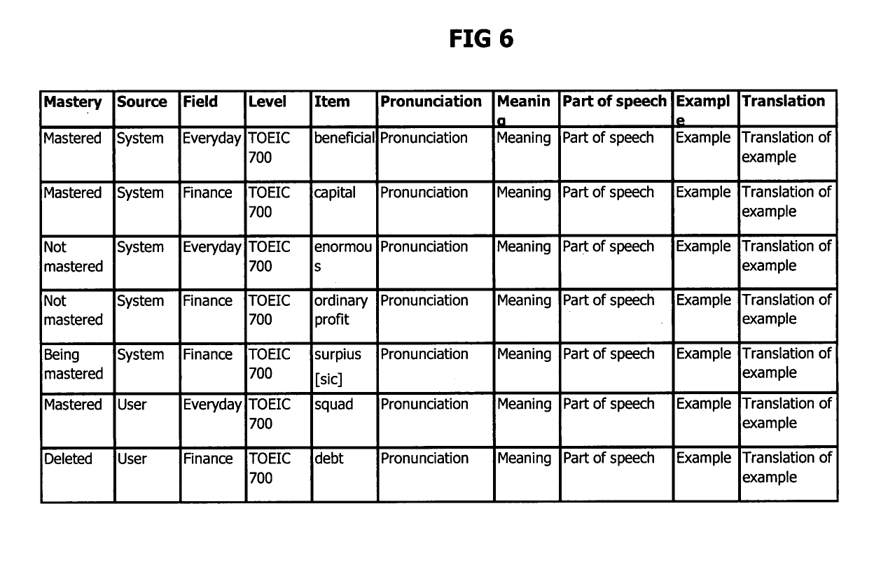

FIG. 6 is a table that lists the items and item attributes that are stored in the second database (My List database) 102. Items and item attributes extracted from the first database 101 are recorded in the second database 102. For example, when the user has input as the study goal the fields of Everyday and Finance and reaching the level of TOEIC700, items that have the fields Everyday or Finance and the attribute TOEIC700 are extracted and stored in the second database 102. The study goals are not limited to the above but include other study fields, test types, score goals, and the like.

The second database 102 records items associated with a mastery attribute that indicates whether an item has been mastered or not and a source attribute that, when an item is added, indicates where the item was added from. Items whose mastery attribute is Not Mastered or Being Mastered may be extracted when second item extraction means 108 extracts items for study in the current session. When the mastery attribute is Mastered or Deleted, the item may not be extracted.

Mastered and Deleted are used differently in checking progress and can be used to manage progress by flagging items. Let us say, for example, that 500 words must be mastered to achieve a study goal and the user has added 50 items to My List during study. In this case, the total number of items that must be studied is 550. If the user then deletes 10 items, the total number of items for study is 550−10=540. The degree of progress (%) is represented by (Number of mastered items)/(Total number of items for study), so distinguishing items with Mastered attributes from items with Deleted attributes preserves the history of the items to be deleted and allows accurate management of the degree of progress (%). Likewise, the distinction between Not Mastered and Being Mastered is useful in checking study progress. Not Mastered indicates that no study has been conducted, while Being Mastered indicates that the item has not been completed, but it has been studied multiple times.

For the source attribute, items extracted from the first database 101 in study system 1, for example, may be recorded as “System” while items added later by the user may be recorded as “User.” By distinguishing items in this way, study can be concentrated on items whose source is, for example, “System,” so learning places emphasis on achieving study goals.

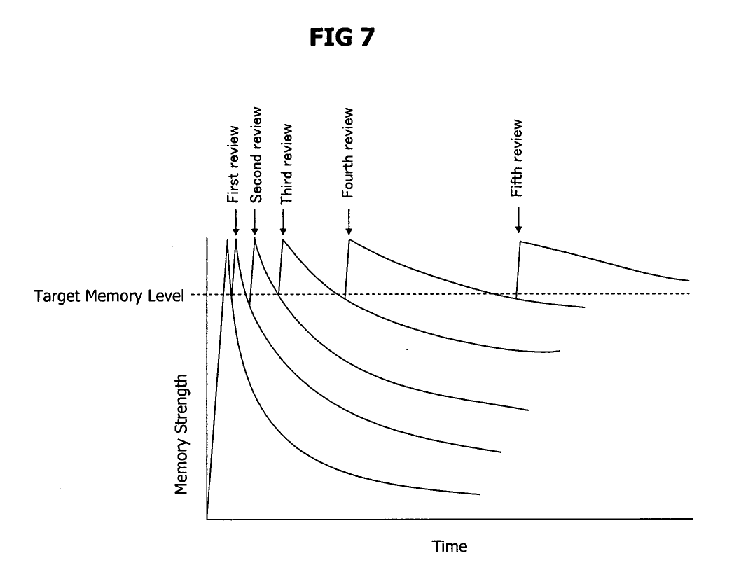

Next, we will explain the Expanded Rehearsal Series theory that scheduling means 106 uses when it is making a schedule that involves review of items, which is described in more detail in U.S. Pat. No. 6,652,283. FIG. 7 is a graph that illustrates the Expanded Rehearsal Series. The vertical axis of the graph indicates the strength of memory while the horizontal axis indicates time. The lines marked “First,” “Second,” and so on in the graph indicate reviews.

The Expanded Rehearsal Series is a series of intervals in learning that spaces out rehearsals (reviews) for greatest retention or memory effect. Rehearsals based on the Expanded Rehearsal Series will have successively greater intervals between them. When reviews follow the Expanded Rehearsal Series, fading memory is revitalized, making it easier for learned knowledge to be stored in long-term memory, increasing the rate of recall. Conducting rehearsals after memory has begun to ebb somewhat strengthens memory, so it is more effective to lengthen the intervals between rehearsals as memory diminishment lessens. To maintain the targeted memory level, it is effective to review with slightly longer intervals each time, as shown in the figure. The study device uses this Expanded Rehearsal Series to present a single item at gradually increasing intervals to allow it to be more effectively lodged in memory. Also, the study interval is adjusted by compressing the review interval when specific conditions are met, such as making mistakes on a test. The result is to enable mitigation of dissipating memory strength. The work for the user can also be reduced by automatically managing the review interval.

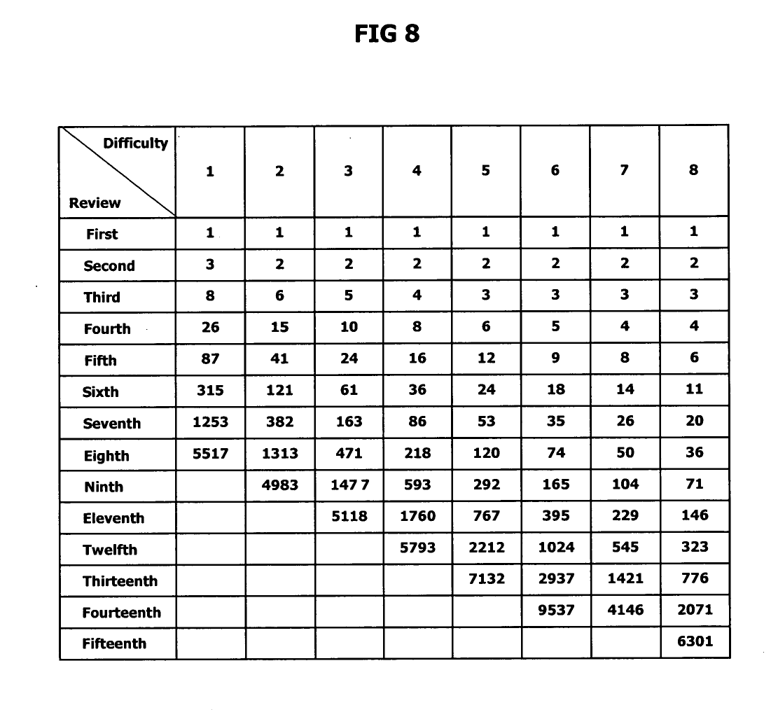

FIG. 8 is a table that shows the review curve. The numbers in the table indicate the time when review should occur in days from the time the item is first studied. As FIG. 8 shows, the easier an item is, the longer the review interval becomes. For example, a difficulty may be recorded in the first database 101 associated with each item, a table like that of FIG. 8 is recorded, and second item extraction means 108 may extract items so the review interval for studied items approaches the review curve table. For example, if the difficulty of “previous” is 3, scheduling means 106 schedules a second review for two days after “previous” is first studied by the user and a third review five days after the first study. When a user's response was wrong in a test conducted during review, its difficulty can be raised one step to shorten the review interval from its original length. For example, if an item of difficulty 3 was missed on a test during the third review, the next interval can be shortened by two days, from 10 days to eight days.

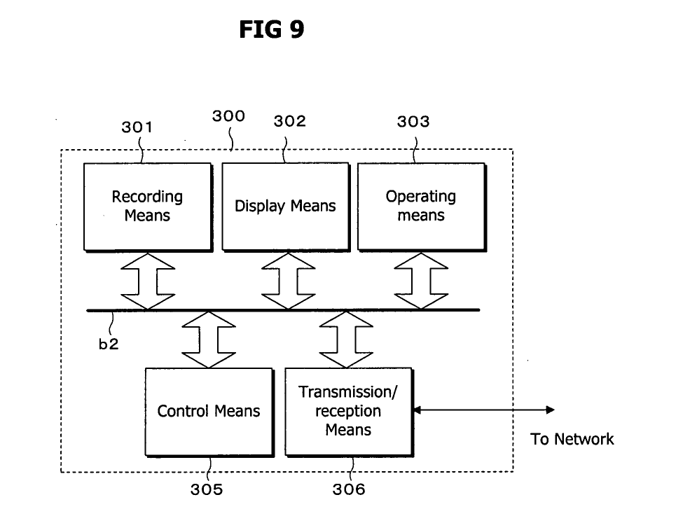

Next, the arrangement of PC 300 as the study terminal will be described. FIG. 9 is a functional block diagram of PC 300. As FIG. 9 shows, PC 300 preferably includes a recording means 301, a display means 302, an operating means 303, a control means 305, and a transmission/reception means 306, all of which are connected by a control bus b2.

Recording means 301 records the learning application, received information, user information, and the like. Recording means 301 preferably includes memory such as RAM or ROM or external memory devices such as hard disks.

Display means 302 displays selection screens for various operations and study content. Display means 302 is preferably a liquid crystal display, but is not limited to this and may be constituted by a CRT display, plasma display, or organic EL display. It may also be provided with a sound data outputting means (not shown), such as a speaker.

Operating means 303 is preferably a keyboard, buttons, or pointing devices such as a mouse and accepts user operations. For example, when potential content is displayed on display means 302 and PC 300 is in a state to accept a selection, it might be possible to select the content to be studied using input from a keyboard or a mouse.

Control means 305 preferably includes a CPU and a computer program executed by the CPU and controls all the individual components. Transmission/reception means 306 is an interface for PC 300 to network 200 that transmits content selection information and receives study content. Control bus b2 is conceptually shown as a trunk line that is used to send and receive signals and data between the individual components.

In the preceding explanation, it was stated that study system 1 is operated preferably via network 200, but it is possible to do everything from setting goals to creating My List and providing study content using a stand-alone study device that has a display means and an operating means, without going through network 200.

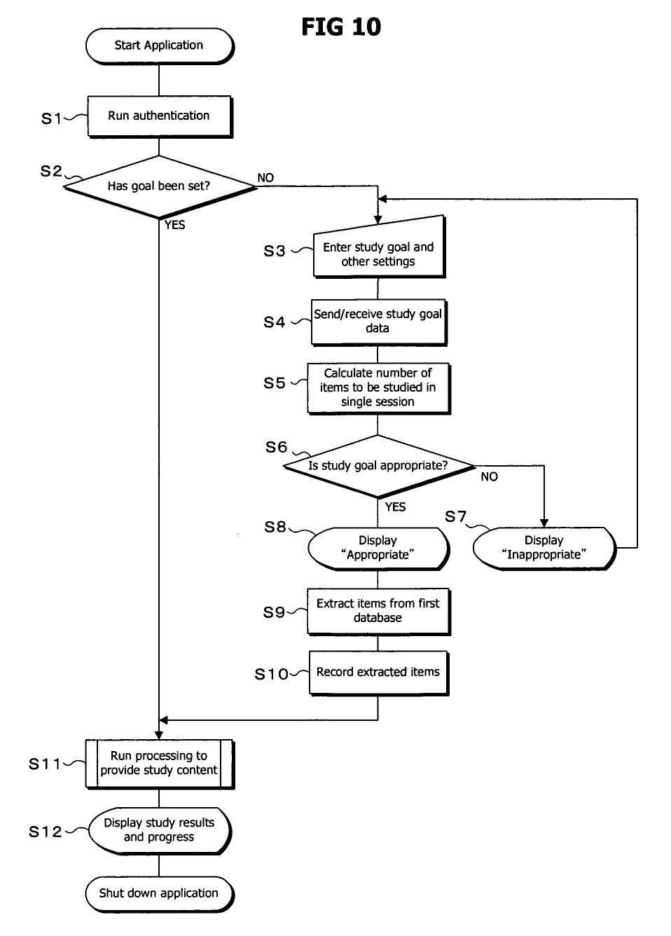

Next, operation of study system 1 as described above will be explained. FIG. 10 is a flowchart showing the characteristic operations of study system 1.

First, when the learning application is started up in PC 300, PC 300 communicates with study device 100 and study device 100 runs an authentication process that authenticates the user and study terminal (Step S1). Next, study device 100 decides whether the study goal has already been set (Step S2). If the goal has not yet been set up, PC 300 displays a study goal setup screen on display means 302 and accepts study goal and other input from the user (Step S3). Some of the other information input besides study goal include study period, amount of study per session, and study interval. These will be described in more detail later. PC 300 transmits the study goal data, and study device 100 receives the study goal data (Step S4). Scheduling means 106 calculates the number of items to be studied in one learning session (Step S5).

Scheduling means 106 decides based on the calculation result whether the study goal is appropriate (Step S6). For example, a set criterion might be established that decides studying over 40 items in a single session is inappropriate. When it decides that the study goal is not appropriate, study device 100 sends that information to PC 300, and PC 300 indicates on display means 302 that it is inappropriate (Step S7).

When the study goal is appropriate, study device 100 sends that information to PC 300, and PC 300 indicates on display means 302 that it is appropriate (Step S8). Then, first item extraction means 107 extracts items required to achieve the study goal from the first database 101 (Step S9). First item extraction means 107 records the extracted items in the second database (My List database) 102 (Step S10). The process then advances to Step S11.

If the study goal is already set, study device 100 runs a process to provide study content (Step S11). The process to provide study content is processing that includes extracting potential content, selecting content, and creating study content. Details will be described later. Once the process to provide study content is completed, the learning results and progress status are displayed (Step S12), and PC 300 shuts down the application. Display of learning results and progress status might refer to, for example, displaying the number of items of content studied in the session, the time that was required to complete the study, the number of new items studied, and the number of items not studied.

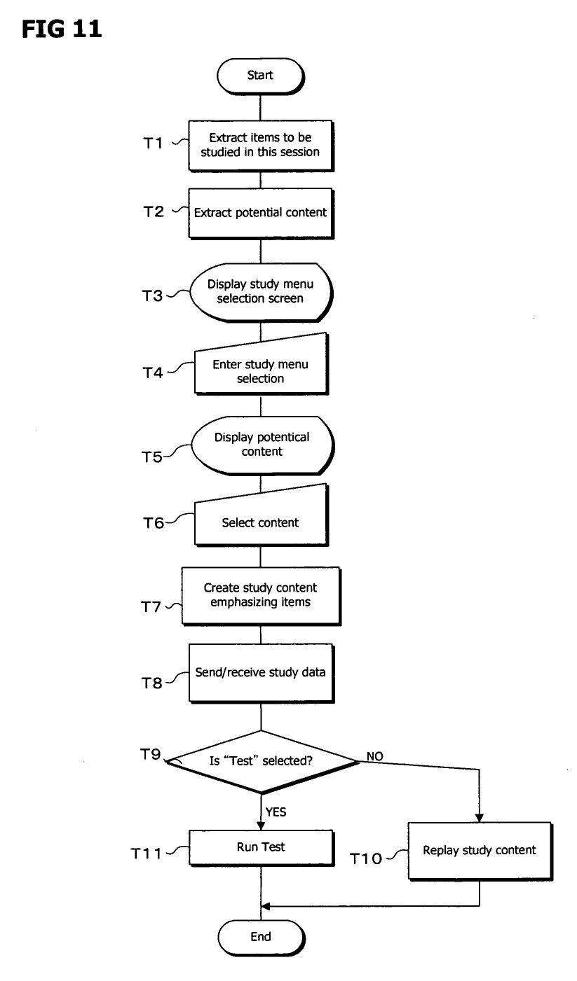

FIG. 11 is a flowchart that shows the process to provide study content. When the process to provide study content starts, second item extraction means 108 extracts items to be studied in the current session from the second database 102 (Step T1). New items for study, items for review, and test items are extracted as the items to be studied in the session. Next, content extraction means 110 extracts content that contains many of the items to be studied in the session from the content stored in the third database 103 as potential content (Step T2). New items for study, items for review, and test items are each extracted separately as potential content.

Study device 100 sends data indicating the potential content extracted to PC 300, and PC 300 displays the selection screen of the study menu (Step T3). The study menu contains New Item, Review and Test. PC 300 accepts input from the user to select from the study menu (Step T4). Once it receives study menu input, PC 300 displays potential content corresponding to the input study menu selection (Step T5) and accepts operations from the user to select content (Step T6).

Next, first outputting means 112 creates study content that displays, preferably with emphasis, the portions of the study content containing the items to be studied in the session based on the selected content (Step T7) and sends the study content to PC 300. The creation of the display with emphasis might be done by, if stated in HTML format for example, inserting the tags ≦font color=red> . . . </font> around the text to be emphasized, changing the font at the location of the item, or displaying it in bold.

PC 300 receives the study content (Step T8). PC 300 decides whether Test was selected on the study menu (Step T9), and if not, replays study content (Step T10) and ends the process to provide study content. If Test was selected, the test is executed, study content for the test is replayed as part of that (Step T11), and the process to provide study content ends.

An arrangement may also be used in which the contents of the third database 103 can be viewed directly by the user and the desired study content selected from the overall database. In that case, first outputting means 112 matches the selected content to the items stored in the second database 102, and first outputting means 112 creates study content and sends it to PC 300. In its matching, first outputting means 112 checks which items in the second database 102 are included in the selected content.

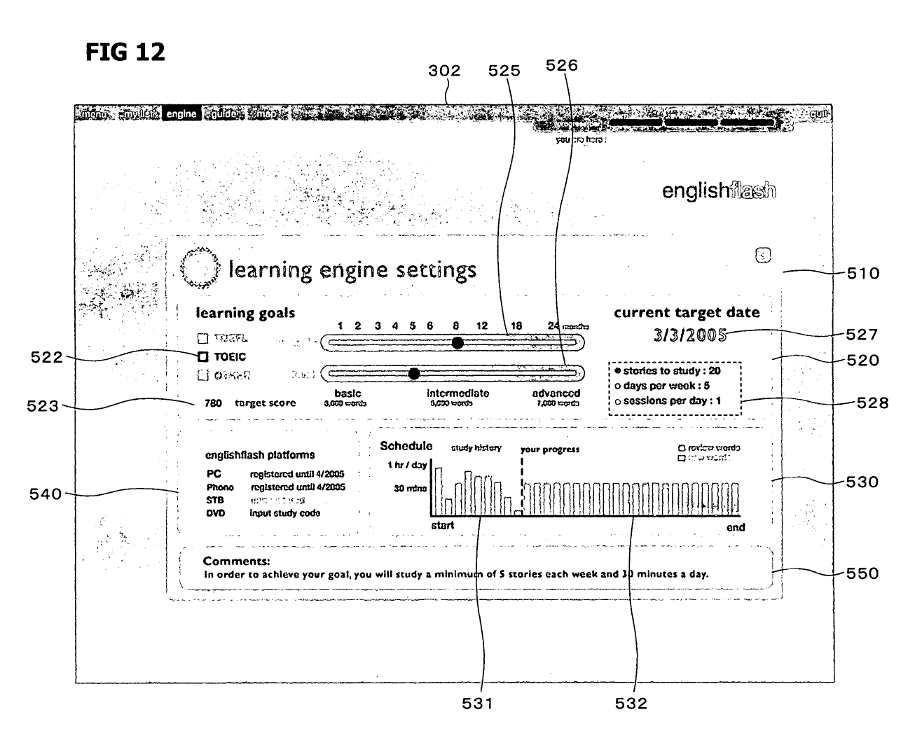

The setup of the aforementioned study goal will be explained. FIG. 12 shows a sample display of the study goal setup screen. As FIG. 12 shows, setup area 510 is displayed in display screen 302 (display means) and setup area 510 is divided into study goal area 520, schedule area 530, study terminal area 540, and comment display area 550.

Study goal area 520 contains check box 522 for selecting the type of test and text box 523 for entering the target score. For example, if the user wants to achieve a TOEIC score of 780, the user selects the TOEIC box in check box 522 to select the test type and enters 780 in text box 523 to enter the target score.

Also, study goal area 520 has period display bar 525 for displaying the study period and level display bar 526 for displaying the current level. The screen display example of FIG. 12 shows period display bar 525 and level display bar 526 that the user is trying to achieve the study goal in eight months and the user's vocabulary level is mastery of 4,500 words.

Study goal area 520 also contains deadline date setup box 527, which sets the day on which the goal is to be achieved. In the screen shot example of FIG. 12, the deadline date has been set by the user to Mar. 3, 2005. Study goal area 520 contains schedule display area 528, which displays the number of items of content to be studied in future, the number of study days per week, and the number of sessions per day. This makes it easy for the user to set up a study schedule for the future. Acceptance and display of these operations is controlled by control means 305 of PC 300.

Schedule area 530 displays graphs of study history to date 531 and future study schedule 532. The horizontal axis of the graph is the period from start of study to end of study, while the vertical axis is the time allocated to study each day. The current position is shown by a dotted line.

Study terminal area 540 shows the study terminal and the registration status. The user registers the study terminal to be used in advance. Comment display area 550 displays comments of various types such as future study pace distribution.

The input study goal data is sent to study device 100 and study device 100 determines its compatibility with study goals using scheduling means 106. The standards for determining compatibility can be set up as shown in the example that follows. To with, the (Total anticipated mastery time) is calculated as the time required for mastery and (Study days)×(Study hours per day)×(Study frequency per week)/7 is calculated as the available study time. When the time required for mastery is below the available study time, control means 115 decides the study goal is appropriate; when the time required for mastery exceeds the available study time, it decides the study goal is inappropriate.

What is referred to here as “anticipated mastery time” is the anticipated study time required to master a specific given item. It is preferably set by the program developers, an administrator or instructor, based on experimental data. The anticipated mastery times are stored in item database 101 associated with particular items and the total anticipated mastery time is calculated by totaling these times for the items to be studied. For example, the upper limit of the anticipated mastery time will change between a person whose current TOIEC score is 700 who is targeting 800 points and a person whose current TOIEC score is 600 who is targeting 800 points.

Generally, the number of items required to achieve the study goal is calculated and the required mastery time predicted from the total for that number of items. If content is also factored in, the total anticipated mastery time is determined using the following equation: (Total anticipated mastery time)=(Time required to master one study item)×(Number of items required to achieve goal)+(Time to replay one piece of content)×(Number of content replays required to achieve goal).

The time required to master one item is calculated by running simulations based on past user data in other systems and recorded associated with each item. The mastery time may be calculated from results data derived from experimental operation on target users.

The number of items required to achieve the goal is the number of items set for each theme, for example, 1,000 words required to achieve TOEIC 700. Further, it can also be determined by calculating the number of items required to get from the user's current level to the goal. For example, if no current level has been input, then the number of items required to get to a goal of TOEIC 700 is 1,000 words, but if the current level is set at TOEIC 500, then the 1,000 words required to get to TOEIC 600 is also included, making a total of 2,000 words. This number of items is calculated by scheduling means 106, and the extraction of items according to the aforementioned number of items is done by first item extraction means 107.

Alternatively, an anticipated total mastery time may be set up for each study goal instead of the anticipated mastery time for each item. The time required to study a single item of content is calculated from the length of the average story and is recorded in advance in content database 103 associated with the individual content piece. The number of study sessions required to achieve a goal is calculated from the number of items required to reach the goal and the number of items studied in one study session. The number of study items to be studied in one study session is recorded in advance in memory. For example, the average number of vocabulary words for one study session at a TOEIC 500 score level is 15, while the average number of vocabulary words for one study session at a TOEIC 700 score level is 10.

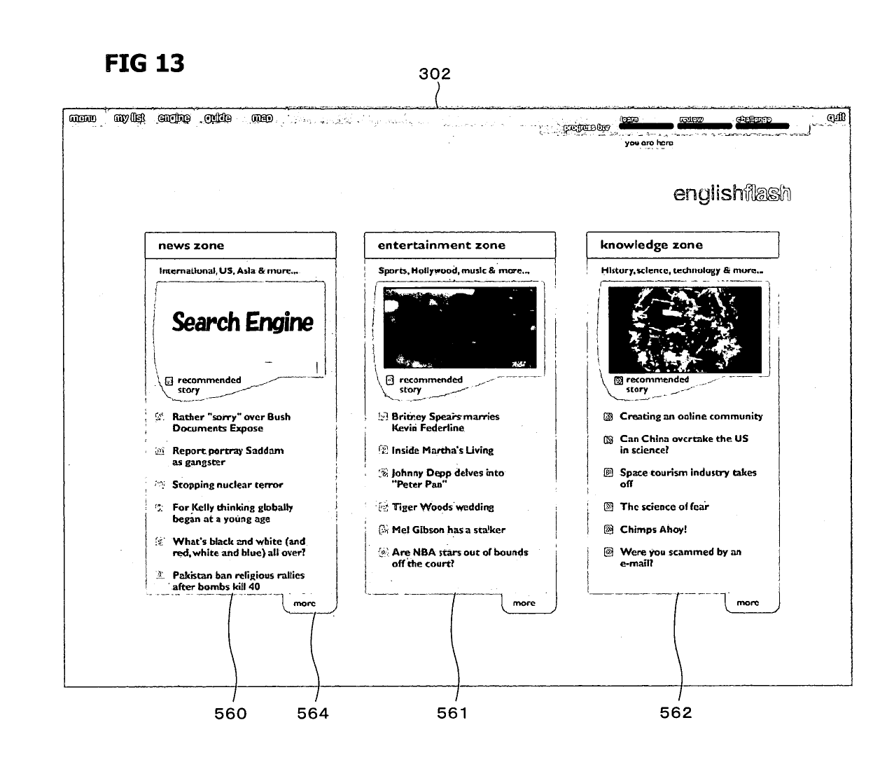

Next, we will explain how content is selected for study from the potential content. FIG. 13 shows a sample display of the content selection screen. The screen shows how data output to PC 300 by content extraction means 110 is displayed on display means 302 by PC 300. As FIG. 13 shows, display screen 302 is divided into news zone 560, entertainment zone 561, and knowledge zone 562. Display screen 302 lists potential pieces of content ranked according to specific criteria so that the user can select them preferentially. The user can preferentially select content that is highly effective for learning. Since the listed content is extracted from a wide range of content and is personally selected by the user, the user can find content that will not bore him or her and will ensure that the user will more quickly and efficiently achieve the learning or study goal.

News zone 560 displays potential content from domestic, foreign relations, science, and other news programs, entertainment zone 561 displays potential content from films and dramatic programs, and knowledge zone 562 displays potential content from programs on world heritage and space.

In each zone, click on tag 564 to advance to the next potential content. When the “Story” button is clicked, study content is created for that story. Acceptance and display of these operations are controlled by control means 305 of PC 300.

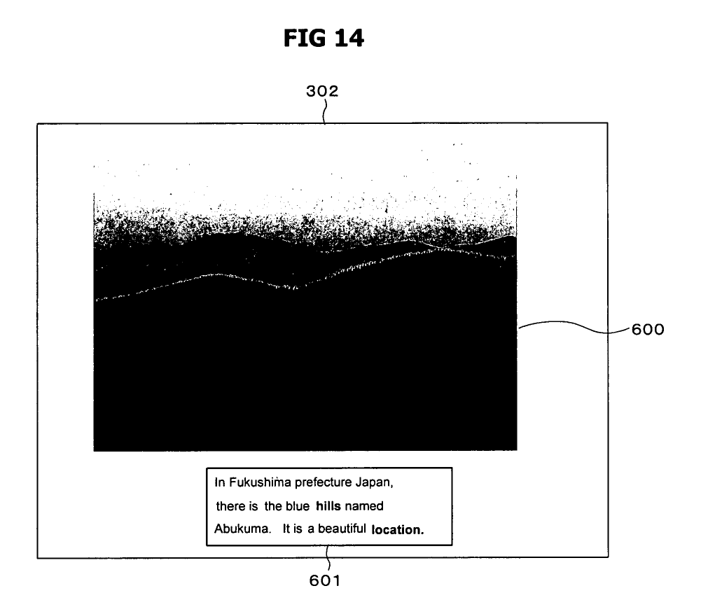

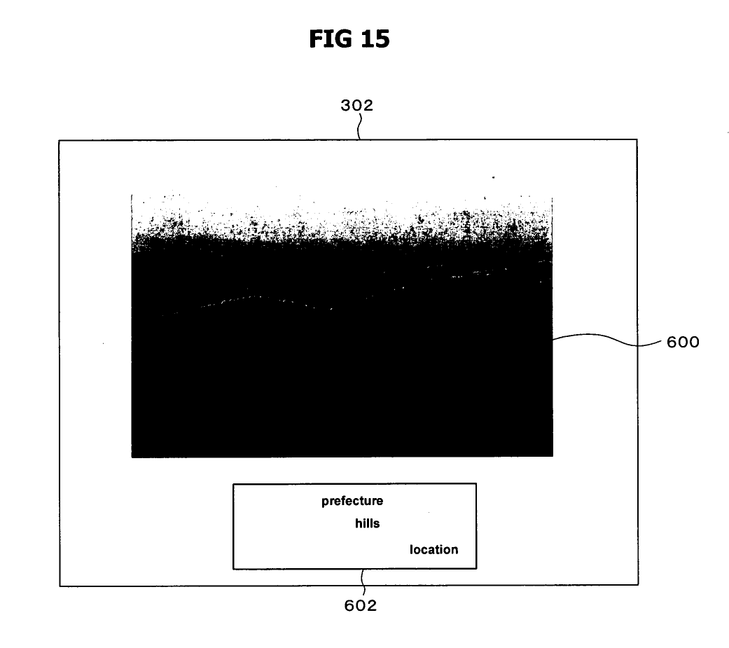

Next, we will explain the replay of study content. FIGS. 14 and 15 show screens for replaying study content. In the display example of FIG. 14, image 600 is displayed on display screen 302 with text 601 describing a story. The items to be studied in the session are emphasized in text 601 using boldface type, for example. In FIG. 15, only the items to be studied in the current session, such as “prefecture,” are displayed in text 602; all other text has been removed, emphasizing the items to be studied in the current session. In both examples, sound runs concurrently with text display. Thus, for example, when the other text has been removed, difficulty increases because the items are studied while deducing the unseen text from the sound. The method of emphasis used can thus be selected according to the user's level or preference.

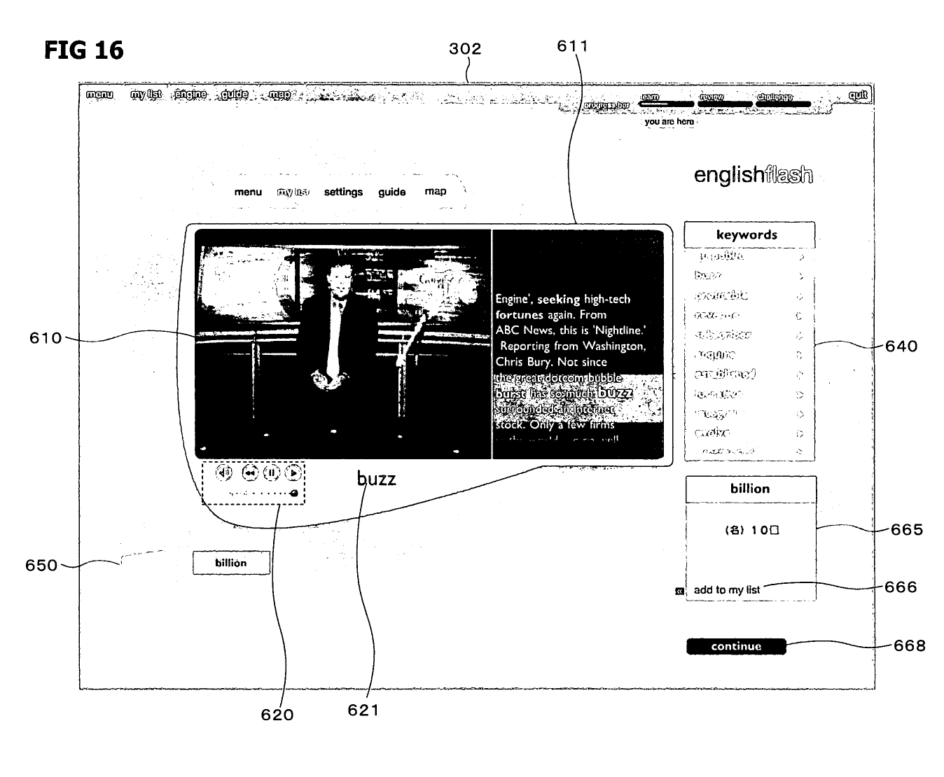

FIG. 16 shows a sample display of study content with moving images. As FIG. 16 shows, display screen 302 contains moving image display area 610 and text display area 611. In the display shown in the figure, the video for a news program is displayed in moving image display area 610, showing a news anchor presenting the news. Sound plays concurrently with the moving image displayed in moving image display area 610, and text is displayed in text display area 611. In the text displayed in text display area 611, the item to be studied in the current session is emphasized. In the example shown in the figure, the word “buzz” is emphasized. Simultaneously, the item to be studied “buzz” is displayed below the moving image display area 610 in large type.

At the bottom of moving image display area 610 is operations area 620, which has buttons marked for replay, pause, and rewind and a volume control bar. Thus, for example, if the user didn't hear something, the user can use the rewind button to listen again. At the right end of display screen 302 is list display area 640, which displays a list of items to be studied. List display area 640 includes two of the items to be studied, “go public” and “buzz,” which are included in the text of the content replayed.

The file icon 650 displayed in the lower left corner of display screen 302 is an icon representing the entrance to My List. Display area 665, which displays a summary of items, is displayed at the lower right of display screen 302 and shows the meaning and part of speech of items the user selects from the text of the content. Display area 665 includes “Add List” button 666, which instructs the program to add an item to My List. At the bottom right corner of display screen 302 is displayed the “Continue” button 668, which is clicked to advance to the next item of study. When the whole story replay has been studied, study moves to individual items. Study can either automatically move to the next screen or proceed when the user is ready and has pressed the “Continue” button 668.

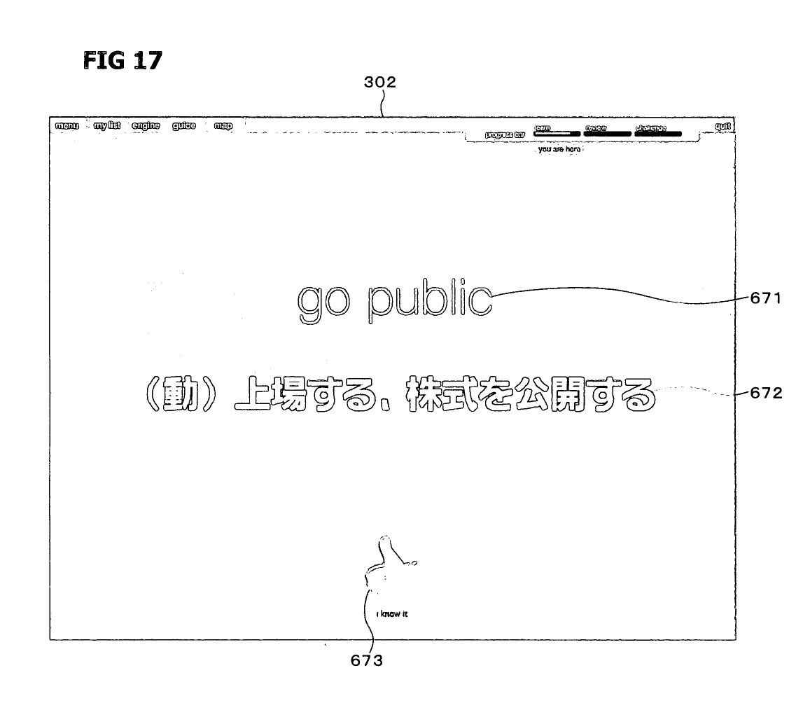

FIG. 17 shows a display example where individual items are being studied. When “go public” is selected from the items listed in list display area 640 in FIG. 16, PC 300 enlarges and displays selected item 671 as shown in FIG. 17 and displays its part of speech and meaning 672 below it. When another item is selected, the display is analogous. Other attributes in addition to part of speech and meaning may also be displayed. Icon 673 is a button for advancing to the next item when study of an item's meaning and part of speech is over (i.e., a “Next” button).

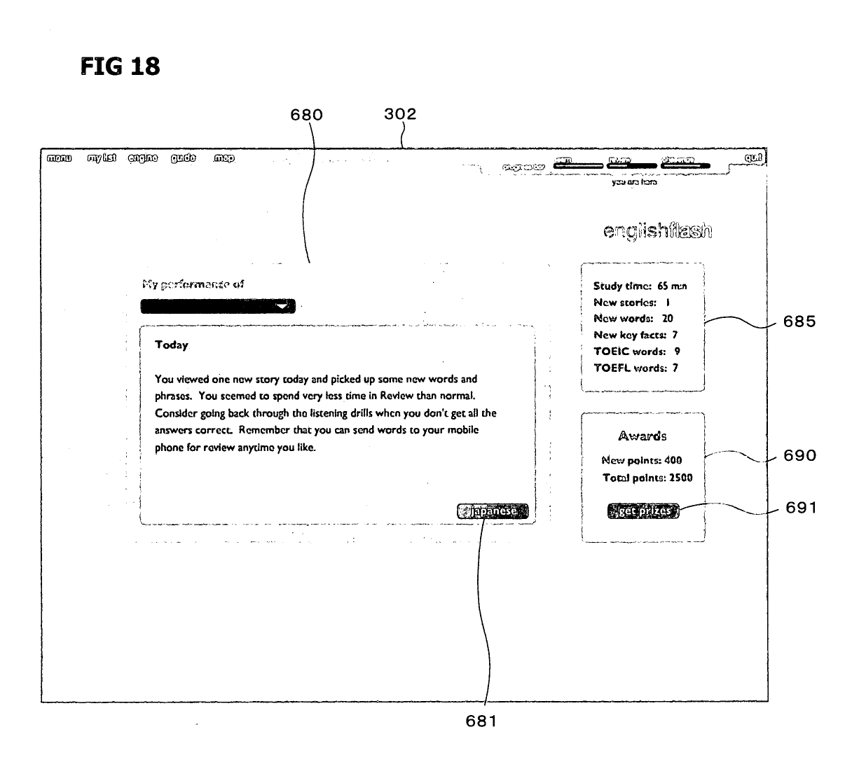

Next, display of study results and progress will be explained. Display of study results and progress is set up so that the user can check it either before, during or after study. FIG. 18 shows a sample display of study results and progress. When the study results and progress are displayed, display area 680 is created for study results in display screen 302. Study results display area 680 displays the subject matter studied in the current session, such as the number of pieces of content studied and the number of items, and simultaneously displays advice or the like. The default is preferably to display in English, for example, but study results can be displayed in Japanese by clicking the “Japanese” button 681, or other suitable languages may also be used. Study results summary display area 685 displays the study results in a simple form, such as numerically. For example, the current session study time, number of new items of content studied, and number of new items studied may be displayed.

Incentive display area 690 displays new points gained by study and the cumulative point total. Display area 690 displays the “Get Prizes” button 691. When the Get Prizes button 691 is clicked, study device 100 awards the user a prize corresponding to the points. For example, when the Get Prizes button 691 is clicked, PC 300 access may be redirected to a site where the user can select products with cartoon characters. The user can select the products, enter address information and the like, and have the products mailed to himself or herself later. Incentives can take many different forms and are not limited to this example. Also, acceptance and display of these operations are controlled by control means 305 of PC 300.

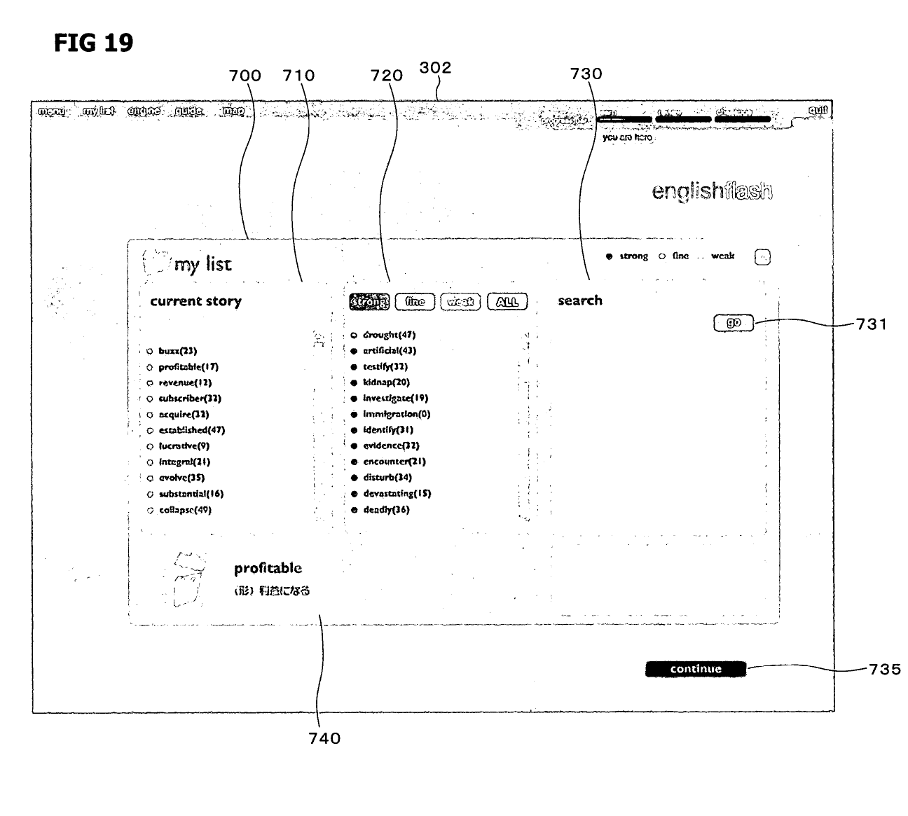

When the My List icon is clicked on the FIG. 16 display screen, PC 300 displays items included in second database (My List database) 102 as My List. PC 300 accepts editing operations done by the user on My List. FIG. 19 shows a sample display of the My List editing screen. Display screen 302 contains My List display area 700, which displays the contents of My List. My List display area 700 contains display area 710 for items contained in current content, display area for all stored items 720, item search area 730, and item-meaning and part-of-speech display area 740, which is used by placing the cursor over the item. Each item displayed is accompanied by the number of times it appears in the potential content in parentheses. Display area for all stored items 720 has buttons labeled “Strong,” “Fine,” “Weak,” and “All.” Clicking these buttons arranges items by strength of recall. For example, the user can click Strong to gather all the items for which the user has strong recall at the front.

Study device 100 is designed to allow items to be added to or deleted from My List at any time using second database updating means (My List updating means) 111. There are times when a user wants to study an item, but it has not been extracted from the study goal setup and included on My List. The operation of adding an item to My List is explained below.

The user operates PC 300 to select the item to be added and selects (clicks) the Add List button. Information on the selected item is sent to study device 100 and recorded in the second database (My List database) 102. Items added in this manner are treated the same as pre-existing items. For example, when 100 words are newly added, they can be evaluated to determine their compatibility with the study goal to determine whether the study goal can be achieved. In that case, study device 100 sends advice data to PC 300 to change the targeted study end date or the like and PC 300 displays the data using display means 302.

The user may in some cases want to delete an item from My List. There may be items that the user decides he or she does not need to study any more. In such cases, the item can be selected, and the My List Delete button selected to delete the item. In such cases, PC 300 sends the deletion information to study device 100, and the item attribute is changed to Deleted by second database updating means (My List updating means) 111. When study device 100 determines that the user has mastered a specific item, that item can be removed from presentation to the user by giving it a Mastered attribute. This means that the user can only delete an item when study device 100 still considers that item to be one which requires study.

For example, when the user has selected the specific item “previous” to be deleted, second database updating means 111 flags the item “previous” as Deleted in the second database (My List database) 102. When the user wishes to again study the study item “previous,” the user selects “Study Again” to send information to study device 100 and activate second database updating means (My List updating means) 111 to return the item “previous” to a status allowing it to be studied. When the user has selected an item to study again, the Deleted flag for the item “previous” in the second database (My List database) 102 is changed to Not Mastered. In the preferred embodiment described above, learning device 100 extracts potential content from multiple sources of content stored in content database 103, but content for use in study can also be determined in advance. It is noted that the content database 103 is preferably a database containing new, up-to-date content in various formats that is not traditionally prepared for learning or study, but that contains items to be learned and studied by a user based on the user's input study goal. In that case, users with different study goals will study using the same content. The items to be studied will differ depending on study goal, but first outputting means 112 will emphasize the items to be studied in its display for the respective users. This means that persons with both high and low knowledge and language ability can study using the same content. Also, users studying different fields can study using the same content as well.

In the above-described preferred embodiments, study device 100 extracted potential content from a third database 103 that is a fixed, closed content database, but potential content may also be acquired from an external server 400 through network 200. Whereas the number of items of content stored in the third database 103 that is a fixed, closed content database is limited, study device 100 can acquire content from an open source of unlimited quantities of content through network 200. In other words, study device 100 acquires content selected from a recording medium or recording device that does not limit content. For example, it may enable use for study of a wide range of content uploaded onto the Web and enable use of an endless supply of new content for study.

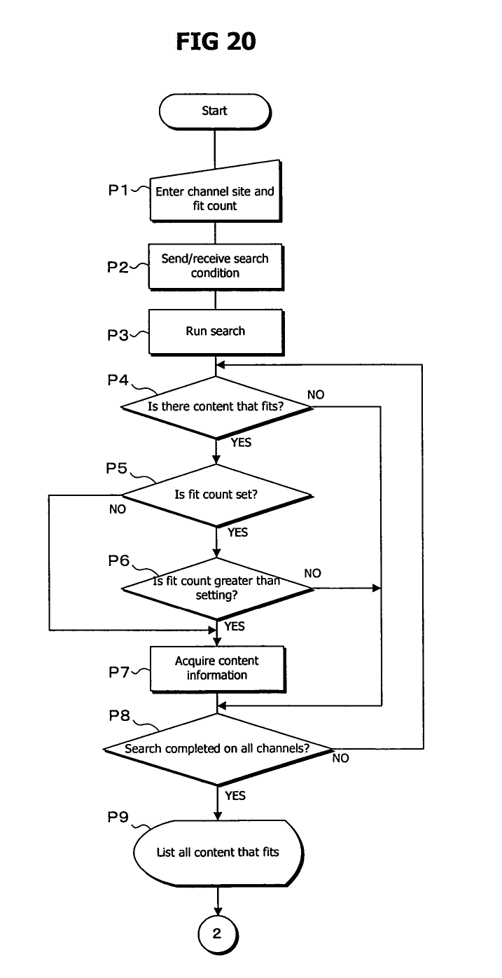

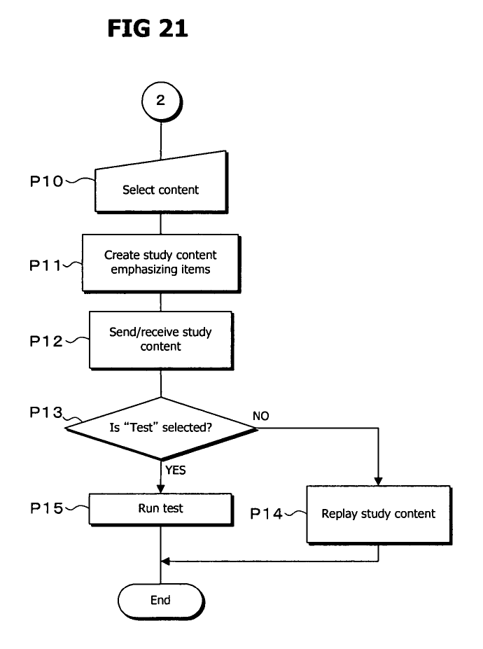

FIGS. 20 and 21 are flow charts that show the process of providing study content when using an open source as the third database 103. When the process for providing study content is started, first PC 300 gets channel site and fit count input from the user (Step P1). A channel indicates a site such as A Finance (http://finance.A.com/) or B Net (http://www.net.B.co.jp/) that is updated constantly. The fit count refers to the number or proportion of items included in the content to be extracted (searched). For example, if the fit count is 10 items, content extraction means 110 would extract content that includes at least 10 of the items contained in item database 101. A high fit count makes for a high threshold, so content selection is more exacting.

Next, PC 300 sends these search conditions to study device 100, study device 100 receives the search conditions (Step P2), and content extraction means 110 runs the search process (Step P3). The search process indicates matching content in a specific site. From the match result, the process determines whether the content fits (Step P4). If the decision is that there is no content that fits, the process proceeds to step P8. If there is content that fits, the process also determines whether a fit count has been set up (Step P5). If there is no fit count setting, the process goes to step P7. If there is a fit count setting, the process also determines whether the fit count with the content is greater than the setting (Step P6). If the fit count with the content is equal to or less than the setting, the process proceeds to step P8.

When the fit count with the content is larger than the setting, the content information of the content is acquired. Content information refers to, for example, the content title and data of typical images, audio, text, etc. Then, content extraction means 110 determines whether the search has ended on all channels (Step P8). If the search has not ended on all channels, the process returns to step P4. When the search has ended on all channels, PC 300 lists the contents that fit (Step P9) and accepts input from the user selecting content (Step P10).

Next, first outputting means 112 creates study content that preferably emphasizes parts with the items to be studied in the selected content (Step P11) and sends it to PC 300. PC 300 receives the transmitted study content (Step P12) and determines whether Test has been selected on the study menu (Step P13). When Test has not been selected, the study content is replayed (Step P14), and the process to provide study content ends. If Test was selected, the test is executed, study content for the test is replayed as part of that (Step P15), and the process to provide study content ends.

In this manner, multiple pieces of content that meet the user's desired conditions are extracted from open sources and the user selects desired content from them, creating a study content with a higher degree of freedom. The extracted content is stored in content database 103 and may be placed in a form that makes it usable for creating study content.

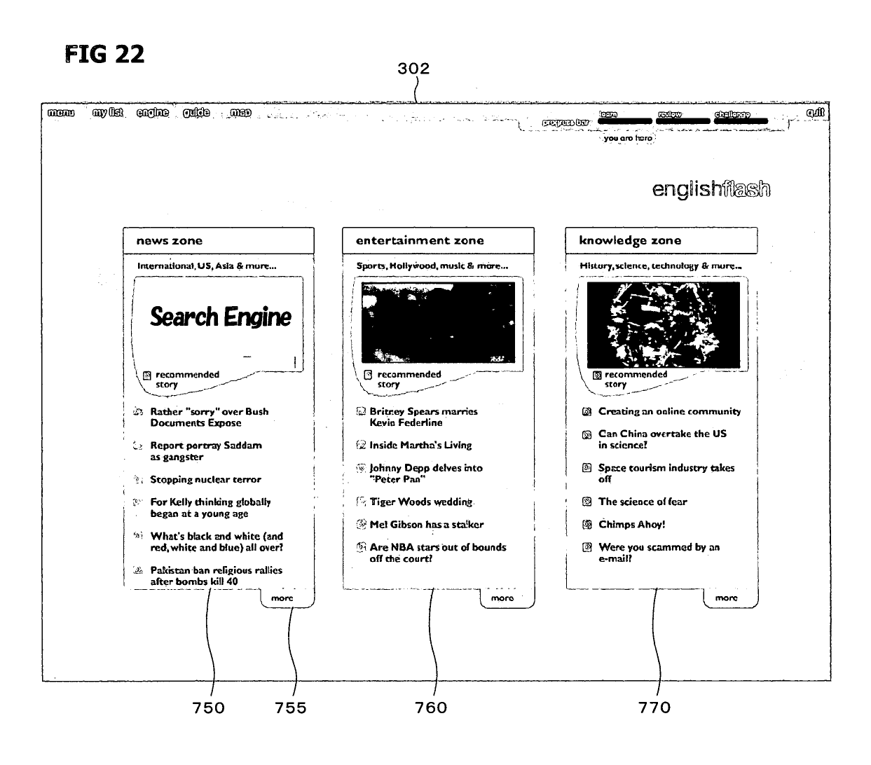

FIG. 22 shows a sample display that lists potential content that fits. PC 300's display screen 302 is divided into news zone 750, entertainment zone 760, and knowledge zone 770, where it displays potential content. News zone 750 displays potential content such as domestic and international news programs, entertainment zone 760 displays potential content such as films and sports, and knowledge zone 770 displays potential content from programs on history and science.

Each zone has a “More” tag 755 that when clicked can display additional potential content. Content is selected by clicking a button at the start of the content title.

Apart from the preferred embodiments described above, study device 100 can directly run emphasis processing on study items included in Web pages found with a browser, and PC 300 can display the processed screens.

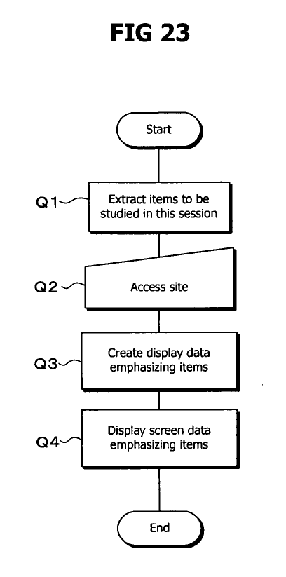

FIG. 23 is a flowchart that shows the process to provide study content by displaying Web pages with emphasis. When the process to provide study content starts, second item extraction means 108 extracts items to be studied in the session from the second database (My List database) 102 (Step Q1), and then, PC 300 uses an application that is already running to browse via study device 100 to access ordinary sites (Step Q2). In other words, study device 100's content extraction means 110 gets specified Web pages and data such as Excel or Word data.

Study device 100 creates image data that emphasizes portions of the content that contain the item to be studied from data in display screens downloaded from accessed sites using content extraction means 110 (Step Q3). Content extraction means 110 matches items in the second database 102 with web pages and files such as Excel and Word files. After matching is complete, content extraction means 110 processes the web pages and Excel or Word files and sends the data to PC 300. For example, if “father” in “My father is a salesman” is an item included in the second database 102, content extraction means 110 changes the HTML statement to “My <font color=red>father</font> is a salesman” to change the representation/color of “father” to red. PC 300 displays the image data of the site processed for emphasis using display means 302 (Step Q4).

This enables users to gain the opportunity to encounter items outside of study times by using study device 100 in a web browser. In such cases, the device can provide deeper understanding and wider knowledge of actual situations where the item is used. It also provides the opportunity to readily replay recordings.

Web pages have been described as an example in the preferred embodiments described above that can provide content from an open source, but content may also be processed within study device 100 when study device 100 displays study content without using a network. For example, if processing Excel or Word files stored in study device 100, there is no longer a need to acquire content through a network. The processed content is not just Web pages, but also all sorts of text data, such as from Excel and Word files.

In the above-described preferred embodiments, explanations used only PC 300 as the study terminal, but continuous study may be provided on different terminals using PCs, PDAs, mobile telephones, STBs, and other processor-based devices.

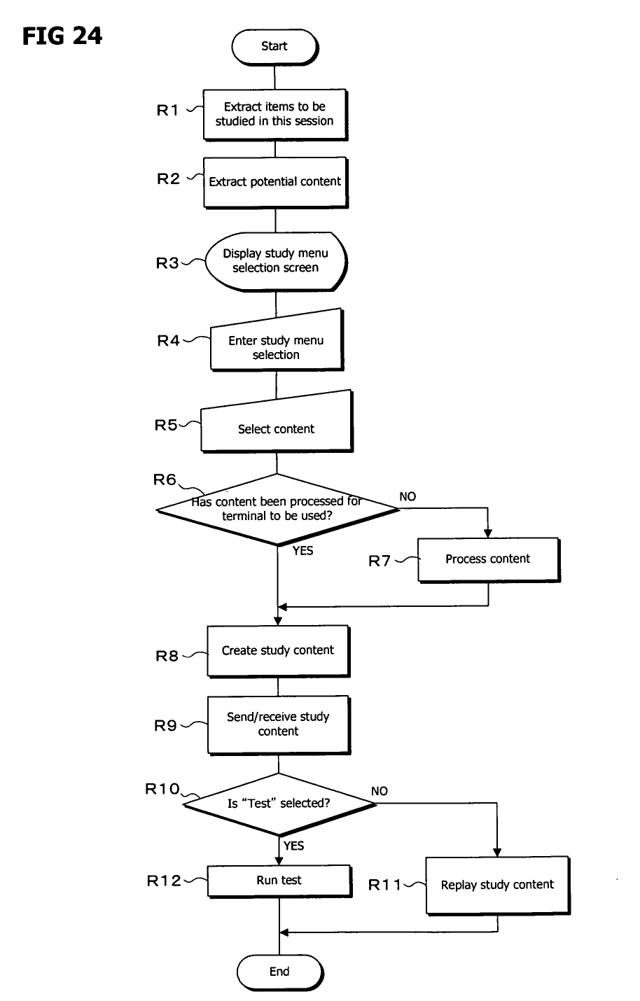

FIG. 24 is a flowchart that shows the process to provide study content that allows use of a variety of study terminals. The user and terminal type are authenticated on study device 100 by authentication prior to processing to provide study content. By doing so, even when the study terminal changes, study can be continued based on the past studied data. For example, after learning on mobile telephone 310, that study data can be included in subsequent learning on PC 300. When the process to provide study content starts, second item extraction means 108 extracts items to be studied in the current session from the second database 102 (Step R1). New items for study, items for review, and test items are extracted as the items to be studied in the session. Since the study terminal sends study history information to study device 100, study can be done continuously even when the study terminal changes, as long as the user is the same.

Next, content extraction means 110 extracts content that contains many of the items to be studied in the session from the content stored in content database 103 as potential content (Step R2). New items for study, items for review, and test items are each extracted separately as potential content.

Study device 100 sends data indicating the potential content extracted to PC 300, and PC 300 displays the selection screen of the study menu (Step R3). The study menu contains New Item, Review and Test. PC 300 accepts input from the user to select from the study menu (Step R4). Once it receives study menu input, PC 300 displays potential content corresponding to the input study menu selection (Step R5) and accepts operations from the user to select content. Content extraction means 110 determines whether the selected content is in a format that can be replayed on the study terminal the user is using (Step R6). This determination is made by accessing information previously recorded in memory such as the type of terminal used by the user and the file formats and sizes the terminals can use. When the result of the determination is that the format cannot be replayed on the study terminal the user is using, content extraction means 110 processes and converts the content into a replayable format (Step R7) and proceeds to (Step R8). The processing process processes the extracted content so it can be replayed on the operating system the user is using. For example, if the PC data in the content is in JPEG format, it is processed into JPEG 120×80 with a compression ratio of 20:1 for mobile telephones. It is advisable in the processing process to create PC, mobile telephone, and STB content in advance.

The user can study in keeping with the study goal using a preferred platform, such as mobile telephone 310 or PC 300. This allows learning to be done on a mobile telephone 310 or the like in environments where PC 300 cannot be used, making it easy to continue studying. Also, this enables selection of a study platform according to one's mood or circumstances, increasing opportunities to study. For example, one could study on PC 300 at night and then continue studying on mobile telephone 310 the next day while commuting on a train.

When the format is one that can be replayed on the study terminal the user is using, first outputting means 112 creates a display of study content with emphasis on the portions with the items to be studied in the current session based on the selected content (Step R8) and sends the study content to PC 300. PC 300 receives the study content (Step R9). PC 300 decides whether Test was selected on the study menu (Step RIO), and if not, replays study content (Step R11) and ends the process to provide study content. If Test was selected, the test is executed, study content for the test is replayed as part of that (Step R12), and the process to provide study content ends.

Also, in the above-described preferred embodiments, content extraction means 110 extracts content data in a format compatible with the study terminal from content data created in advance and stored in content database 103, but content data may be created in a compatible format upon request from a study terminal or other input request.

The various means described above with reference to a CPU and a program that is executed on a CPU may be part of one CPU or may be many different CPU or processor-based devices, in any combination thereof.

Also, the various means, elements and steps of the methods, apparatuses and systems described above according to various preferred embodiments of the present invention may take various forms including a signal carrier wave format to be used on an Internet-based system, computer software or machine-executable or computer-executable code for operation on a processor-based system such as a computer, a telephone including a cellular phone, a personal digital assistant, a set top box, or other information transmission device.

Also, the operation of study device 100 and the methods and apparatuses shown in FIGS. 1, 2a and 2b, and those in all of the aforementioned preferred embodiments is preferably by a computer program or software executed on a processor or microprocessor based system, but the present invention is not limited to this.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A method for obtaining and presenting content to a user for studying, the method comprising the steps of:
(a) prompting the user to provide a study goal;
(b) querying and extracting items from a first database based on the study goal provided by the user;
(c) querying and extracting content from a second database based on the items extracted from the first database; and
(d) presenting to the user the content from the second database for study by the user.

2. The method according to claim 1, further comprising the step of storing in a third database the items extracted from the first database before the step (c).

3. The method according to claim 1, further comprising the step of storing in a fourth database the content extracted from the second database before presenting the content extracted from the second database to the user.

4. The method according to claim 1, wherein the first database includes items that are specifically prepared for study and learning and the second database includes content that is not specifically prepared for study and learning.

5. The method according to claim 1, wherein the items extracted from the first database are predetermined to achieve the study goal input by the user if the user learns the items extracted from the first database.

6. The method according to claim 1, wherein the step of presenting to the user the content from the second database for study by the user includes the step of emphasizing each of the items extracted from the first database in the content extracted from the second database.

7. The method according to claim 6, wherein the step of emphasizing includes providing each of the items with a visual or auditory characteristic that is different from that of the content extracted from the second database.

8. The method according to claim 1, further comprising the step of allowing the user to select the second database based on the user's preferences with respect to content to be extracted and presented to the user.

9. The method according to claim 1, wherein the second database is one of a closed database including fixed data stored on a media and an open database that can be accessed via the internet.

10. The method according to claim 1, wherein the step of presenting to the user the content from the second database for study by the user includes presenting to the user at least one of the items extracted from the first database.

11. The method according to claim 1, wherein the step of querying and extracting content from a second database based on the items extracted from the first database includes the step of accessing the internet to extract content from the second database via the internet.

12. The method according to claim 1, wherein the method steps (a)-(d) are performed using one of a microprocessor-based device, a computer, a phone, a game device, a personal digital assistant device, a set top box, and an MP3 player.

13. The method according to claim 12, further comprising the step of switching between using two or more the microprocessor-based device, the computer, the phone, the game device, the personal digital assistant device, the set top box, and the MP3 player in performing the method steps (a)-(d).

14. The method according to claim 1, further comprising the steps of determining a schedule for when each of the items extracted from the first database should be presented to the user and using the items extracted from the first database based on the schedule for querying and extracting content from the second database.

15. The method according to claim 1, wherein the first database is an item database and the second database is a content database.

16. The method according to claim 2, wherein the third database is a My List database of items selected specifically for the user.

17. An apparatus for obtaining and presenting content to a user for studying, the apparatus comprising:
an input means for allowing a user input a study goal;
a first item extracting means for querying and extracting items from a first database based on the study goal input by the user;
a content extraction means for querying and extracting content from a second database based on the items extracted from the first database; and
a first outputting means for outputting and presenting to the user the content from the second database for study by the user.

18. The apparatus according to claim 17, further comprising means for storing the items extracted from the first database in a third database, a scheduling means for determining when each of the items extracted from the first database and stored in the third database should be presented to the user, and a second item extraction means for extracting items from the third database based on the schedule determined by the scheduling means and providing the items extracted from the third database to the content extraction means for querying and extracting content from the second database.

19. The apparatus according to claim 17, further comprising means for storing in a fourth database the content extracted from the second database before presenting the content extracted from the second database to the user.

20. The apparatus according to claim 17, wherein the first database includes items that are specifically prepared for study and learning and the second database includes content that is not specifically prepared for study and learning.

21. The apparatus according to claim 17, wherein the items extracted from the first database are predetermined to achieve the study goal input by the user if the user learns the items extracted from the first database.

22. The apparatus according to claim 17, wherein the means for outputting and presenting to the user the content from the second database for study by the user includes means for emphasizing each of the items extracted from the first database in the content extracted from the second database.

23. The apparatus according to claim 22, wherein the means for emphasizing includes means for providing each of the items with a visual or auditory characteristic that is different from that of the content extracted from the second database.

24. The apparatus according to claim 17, further comprising means for allowing the user to select the second database based on the user's preferences with respect to content to be extracted and presented to the user.

25. The apparatus according to claim 17, wherein the second database is one of a closed database including fixed data stored on a media and an open database that can be accessed via the internet.

26. The apparatus according to claim 17, wherein the means for outputting and presenting to the user the content from the second database for study by the user includes means for presenting to the user at least one of the items extracted from the first database.

27. The apparatus according to claim 17, wherein the content extraction means includes means for accessing the internet to extract content from the second database via the internet.

28. The apparatus according to claim 17, wherein the apparatus is one of a microprocessor-based device, a computer, a phone, a game device, a personal digital assistant device, a set top box, and an MP3 player.

29. The apparatus according to claim 28, further comprising means for switching between using two or more the microprocessor-based device, the computer, the phone, the game device, the personal digital assistant device, the set top box, and the MP3 player.

30. The apparatus according to claim 17, wherein the first database is an item database and the second database is a content database.

31. The apparatus according to claim 18, wherein the third database is a My List database of items selected specifically for the user.

32. A computer-executable program for causing a computer to perform the following steps when the computer-executable program is executed on the computer:
(a) prompting a user to provide a study goal;
(b) querying and extracting items from a first database based on the study goal provided by the user;
(c) querying and extracting content from a second database based on the items extracted from the first database; and
(d) presenting to the user the content from the second database for study by the user.
